(19) United States
(12) Patent Application Publication
(10) Pub. No.: US 2024/0372268 A1
(43) Pub. Date: Nov. 7, 2024

(54) MULTIPLE INPUT MULTIPLE OUTPUT RADAR, ANTENNA ARRAYS AND TRANSMISSION SCHEMES

(71) Applicant: RADSEE TECHNOLOGIES LTD., HERZLIYA (IL)

(72) Inventors: Gregory Lerner, Herzliya (IL); Dani REPHAELI, Kfar Saba (IL)

(73) Assignee: RADSEE TECHNOLOGIES LTD., HERZLIYA (IL)

(21) Appl. No.: 18/572,758

(22) PCT Filed: Jun. 21, 2022
(86) PCT No.: PCT/US2022/034390

§ 371 Date: Dec. 20, 2023

Related U.S. Application Data
(60) Provisional application No. 63/212,683, filed on Jun. 20, 2021.
(60) Provisional application No. 63/212,684, filed on Jun. 20, 2021.

(51) Int. Cl. H01Q 21/00; G01S 13/32; G01S 13/42; H01Q 21/06

(52) U.S. Cl. CPC H01Q 21/0075; G01S 13/325; G01S 13/42; H01Q 21/06

(57) ABSTRACT

A MIMO radar that include at least one segmented coprime array of antennas. The MIMO radar may include one or more linear antenna arrays (LAAs) of transmission antennas and one or more LLAs of reception antennas. A LAA may include one or more spaced apart groups (or segments) of antennas.

### CROSS REFERENCE

This application claims priority from U.S. provisional patent Ser. No. 63/212,684 filing date Jun. 20 2021 and from U.S. provisional patent Ser. No. 63/212,683 filing date Jun. 20 2021—both being incorporated herein in their entirety.

### BACKGROUND

Multiple Input Multi Output (MIMO) radars may be very popular radars. One of the main benefits of MIMO radars includes using a first plurality (K1) of transmission antennas and a second number (K2) of reception antennas to provide an equivalent of a virtual antenna array of K1*K2 virtual antennas.

An example of a state of the art MIMO antenna may be illustrated in PCT patent application WO2018/122849 which may be incorporated herein by reference.

There may be growing need to improve various aspects of MIMO radars such as reduce cost, simplify manufacturing, and improve target detection capabilities of the MIMO radars.

### SUMMARY

There may be provided a MIMO radar that may include (i) a first linear antenna array (LAA) that may include a group of first antennas that may be spaced apart from each other by a first distance; wherein the first distance may equal a first integer multiplied by a basic distance unit; and (ii) a second LAA that may include groups of second antennas that may be spaced apart from each other by a second distance; wherein the second distance may equal a second integer multiplied by the basic distance unit; wherein the first integer and the second integer may be coprime integers. A number of second antennas of each group of second antennas may be a multiple of the first integer. A number of first antenna of the group of first antennas may be a multiple of the second integer. One LAA of the first LAA and the second LAA may be a transmission LAA and another LAA of the first LAA and the second LAA may be a reception LAA.

There may be provided a method for reception and radio frequency transmission by a MIMO radar, the method may include (i) transmitting transmitted RF signals by a transmission linear antenna array (LAA) and (ii) receiving received RF signals by a reception LAA. One LAA of the transmission LAA and the reception LAA may include a group of first antennas that may be spaced apart from each other by a first distance; wherein the first distance may equal a first integer multiplied by a basic distance unit. Another LAA of the transmission LAA and the reception LAA may include groups of second antennas that may be spaced apart from each other by a second distance. The second distance may equal a second integer multiplied by the basic distance unit. The first integer and the second integer may be coprime integers. A number of second antennas of each group of second antennas may be a multiple of the first integer. A number of first antenna of the group of first antennas may be a multiple of the second integer.

There may be provided a MIMO radar, the MIMO radar may include (i) a transmission unit that may be configured to transmit transmitted beamformed symbols; wherein the transmitted beamformed symbols may include transmitted beamformed data symbols and transmitted beamformed sequences of pilot symbols, wherein the receiver- separable beamformed sequences of pilot symbols may be concurrently transmitted and may be receiver-separable; (ii) a reception unit that may be configured to receive received echoes, from one or more targets, of the transmitted beamformed symbols; wherein the received echoes may include echoes of the beamformed data symbols and echoes of the transmitted beamformed sequences of pilot symbols; and (iii) a processor that may be configured to process the received echoes to find the one or more targets, wherein a finding of the one or more targets may include determining, based on the echoes of the transmitted beamformed sequences of pilot symbols, Doppler information regarding the one or more targets.

There may be provided a non-transitory computer readable medium that stores instructions that once executed by a processor, causes the processor to: (i) control a transmitting, by a transmission unit of the MIMO radar, transmitted beamformed symbols; wherein the transmitted beamformed symbols may include transmitted beamformed data symbols and transmitted beamformed sequences of pilot symbols, wherein the receiver-separable beamformed sequences of pilot symbols may be concurrently transmitted and may be receiver-separable; (ii) control a receiving, by a reception unit of the MIMO radar, received echoes, from one or more targets, of the transmitted beamformed symbols; wherein the received echoes may include echoes of the beamformed data symbols and echoes of the transmitted beamformed sequences of pilot symbols; and (iii) process the received echoes to find the one or more targets, wherein a finding of the one or more targets may include determining, based on the echoes of the transmitted beamformed sequences of pilot symbols, Doppler information regarding the one or more targets.

There may be provided a method for MIMO radar operation, the method may include (i) transmitting, by a transmission unit of the MIMO radar, transmitted beamformed symbols; wherein the transmitted beamformed symbols may include transmitted beamformed data symbols and transmitted beamformed sequences of pilot symbols, wherein the receiver-separable beamformed sequences of pilot symbols may be concurrently transmitted and may be receiver-separable; (ii) receiving, by a reception unit of the MIMO radar, received echoes, from one or more targets, of the transmitted beamformed symbols; wherein the received echoes may include echoes of the beamformed data symbols and echoes of the transmitted beamformed sequences of pilot symbols; and (iii) processing the received echoes to find the one or more targets, wherein a finding of the one or more targets may include determining, based on the echoes of the transmitted beamformed sequences of pilot symbols, Doppler information regarding the one or more targets.

### BRIEF DESCRIPTION OF THE DRAWINGS

The subject matter regarded as the invention may be particularly pointed out and distinctly claimed in the concluding portion of the specification. The invention, however, both as to organization and method of step, together with substrates, features, and advantages thereof, may best be understood by reference to the following detailed description when read with the accompanying drawings in which:

FIG. 1 may be an example of some components of a radar;

FIG. 2 may be an example of some components of a radar;

FIG. 3 may be an example of some components of a radar;

FIG. 4 may be an example of a radar;

FIG. 5 may be an example of some components of a radar;

FIG. 6 may be an example of some components of a radar;

FIG. 7 may be an example of a radar;

FIG. 8 may be an example of some components of a radar;

FIG. 9 illustrates actual and virtual linear antenna arrays (LAAs);

FIG. 10 illustrates actual and virtual LAAs;

FIG. 11 illustrates actual and virtual LAAs;

FIG. 12 illustrates actual and virtual LAAs;

FIG. 13 illustrates LAAs;

FIG. 14 illustrates LAAs;

FIG. 15 illustrates LAAs;

FIG. 16 illustrates LAAs;

FIG. 17 illustrates various components of a MIMO radar;

FIG. 18 illustrates an example of a method;

FIG. 19 illustrates an example of various frames;

FIG. 20 illustrates an example of a pilot beam forming;

FIG. 21 illustrates an example of various signals; and

FIG. 22 illustrates an example of a method.

### DETAILED DESCRIPTION OF THE DRAWINGS

In the following detailed description, numerous specific details may be set forth in order to provide a thorough understanding of the invention. However, it will be understood by those skilled in the art that the present invention may be practiced without these specific details. In other instances, well-known methods, procedures, and components have not been described in detail so as not to obscure the present invention.

Any reference in the specification to a method should be applied mutatis mutandis to a system capable of executing the method.

Any reference in the specification to a system should be applied mutatis mutandis to a method that may be executed by the system.

The assignment of the same reference numbers to various components may indicate that these components may be similar to each other.

The following terms and abbreviations may be used:
a. λ (lambda)—wavelength of the signal used for transmission/reception of the radar signal
b. BDU (basic distance unit)—a minimal distance between virtual (or physical) antenna elements in a dense antenna array. A typical dense uniform linear array will consist of

$$\\ \frac{λ}{2}$$

spaced elements for a non-ambiguous angle of arrival. Other values (higher or lower) may be also possible for either better resolution (on expense of antenna array ambiguity) or higher FOV.
c. Uniform step—distance in (in BDU) between antenna elements in ULA.
d. Gap—in case of a segmented array, as distance (in BDU) between consecutive groups of antennas. Note, that the gap may be not necessarily a multiple of the uniform step or the BDU.
e. Group/segment—in case of a segmented array, a ULA group of consecutive antenna elements.
f. δ(x)—a Kronecker delta function.
g. ULA (uniform linear array)—a linear antenna array with equally distant elements.
h. N_{RX}—number of reception antennas.
i. N_{TX}—number of transmission antennas.

### Antenna Schemes for MIMO Radar

Assuming a transmit array with antenna elements located at {x_{T,k}} and receive array with elements at {x_{R,k}} the resulting virtual array may be a convolution of location function the participating arrays, i.e.:

$$\\ {h}_{R} = {\sum }_{k} δ ( x - {x}_{R , k} )$$

$$\\ {h}_{T} = {\sum }_{k} δ ( x - {x}_{T , k} )$$

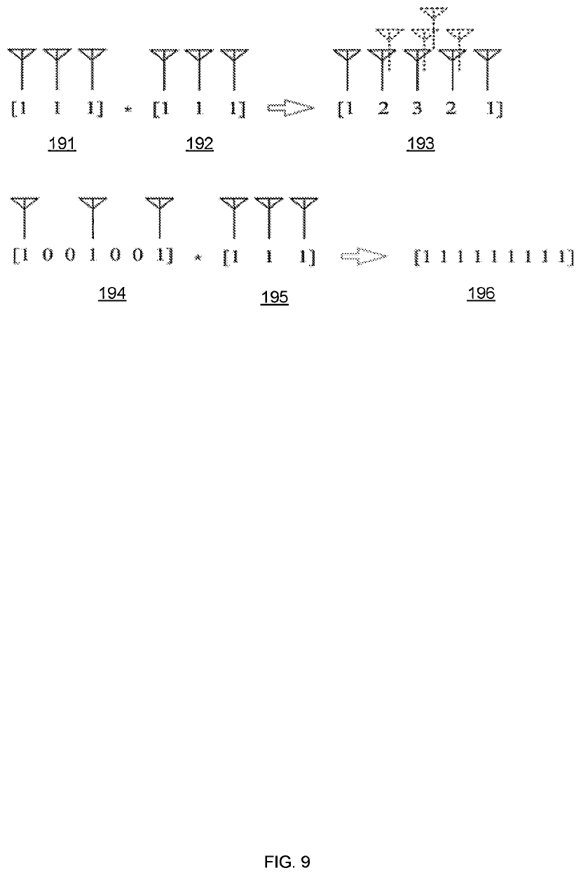

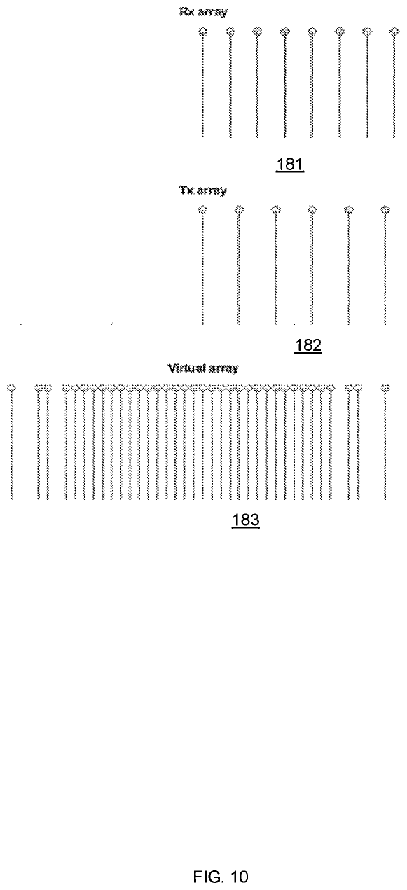

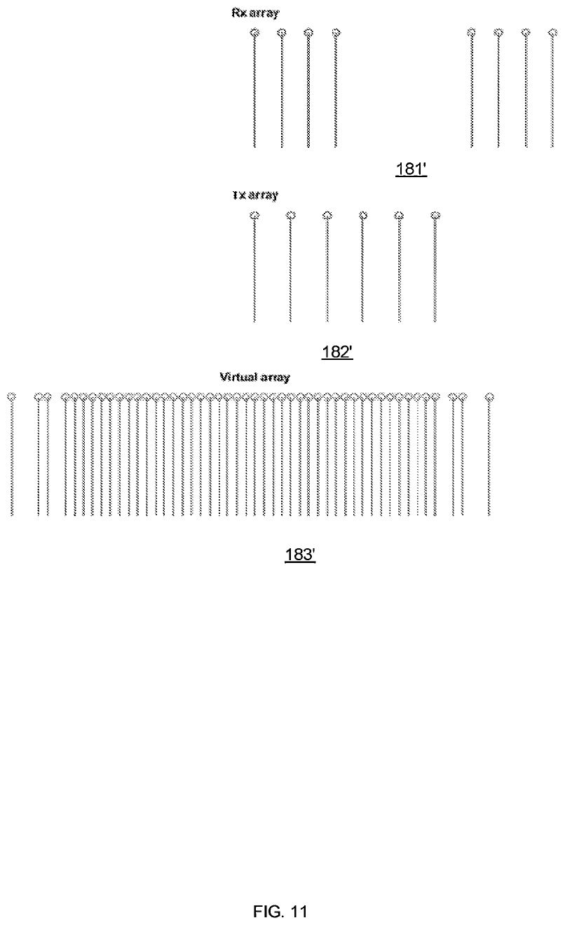

Then the effective virtual antenna array is: h_{V}=h_{T}*h_{R}—see, for example upper part of FIG. 9—in which a single group of evenly spaced transmission antennas 191 and a single group of evenly spaced reception antennas 192 for a virtual linear array of antennas 193.

A MIMO antenna array of the MIMO radar may have random elements locations or may use a nested array approach—splitting the whole set of receive (or/and transmit) antennas into several arrays and utilizing each one as an additional antenna array, this way allowing for higher order convolution (more than two arrays may be convolved to generate “virtual antennas”).

Let's assume we have a pair of coprime ULA antenna arrays for transmit and receive, with antenna elements may be separated by

$$\\ \frac{λ}{2} {d}_{T} and \frac{λ}{2} {d}_{R}$$

in each one accordingly, where

$$\\ \frac{λ}{2}$$

may be a basic distance unit (BDU), typically equal to half wavelength. Other antenna BDU options can be used to achieve either very wide field-of-view (FOV) or better resolution on expense of narrower FOV. The array may be a “coprime” array if d_{T} and d_{R} (uniform step of the arrays) may be coprime integer numbers.

If the total length of each of the arrays in BDU may be beyond LCM(d_{T}, d_{R}), where LCM denotes least common multiple, then some of the virtual antenna elements will be multiply defined (represented by more than a single pair of physical elements). As the antenna array size (aperture) grows, so the number of multiply defined virtual elements. In other words, if d_{T} and d_{R} may be virtually coprime, and there's a multiply defined virtual element at pair of antennas located at (t₁,r₁) and (t₂,r₂), then one can conclude that:

$$\\ \frac{{t}_{1} + {r}_{1}}{2} = \frac{{t}_{2} + {r}_{2}}{2} \text{=>} {t}_{1} - {t}_{2} = {r}_{2} - {r}_{1} \text{=>}$$

$$\\ {Kd}_{T} = {Md}_{r} for K , M ∈ ℕ$$

$$\\ {d}_{R} \vert {Kd}_{T} \text{=>} LCM ( {d}_{T} , {d}_{R} ) \vert {Kd}_{T}$$

This means that array may be sub-optimal for the given number of physical elements and can be optimized by either further increase in the aperture or reduction of the physical antenna elements.

An obvious approach can be to use larger uniform steps (d_{T} and d_{R}). This way the LCM(d_{T}, d_{R}) will grow and so the antenna array will be closer to optimal. This approach has several drawbacks:
a. Each of the antennas (transmit or receive) will have denser spatial self-ambiguity.
b. Size of the less efficient portion of the array (due to “holes” in the virtual array) grows, so with the overall antenna aperture increase the efficiency not necessarily improves.

It may be suggested to use coprime linear Tx and Rx array principle, while reducing amount of antenna elements by skipping certain elements, creating segmented coprime antenna arrays. All that while keeping the dense virtual MIMO antenna array.

Instead of uniform linear array (ULA) arrangement of antenna elements use a sequence of ULA sub-groups arranged with some gap between them, bigger than antenna element spacing.

The gap may be to be designed in a way that still provides a dense

$$\\ ( \frac{λ}{2} ‐ {}_{} spaced )$$

virtual array.

At least one of the following rules of thumb may be used to design the segmented coprime array:
a. In general, keeping the antenna elements on the same “grid of the original linear array” can be used, i.e., the gap can be a multiple of the original array uniform step (distance between antenna elements). This design maximizes the antenna array physical aperture. Please note, that using of a gap not scaled to the array's uniform step may be also possible, though it will require a smaller gap between the element groups, and so will result in a suboptimal antenna aperture.
b. Each segment of the array at one side shall be sized at least equal to the uniform step of the array at the other side (e.g., if the Rx array has uniform step d_{R}=4, then the Tx array shall be segmented into groups of at least 4 elements).

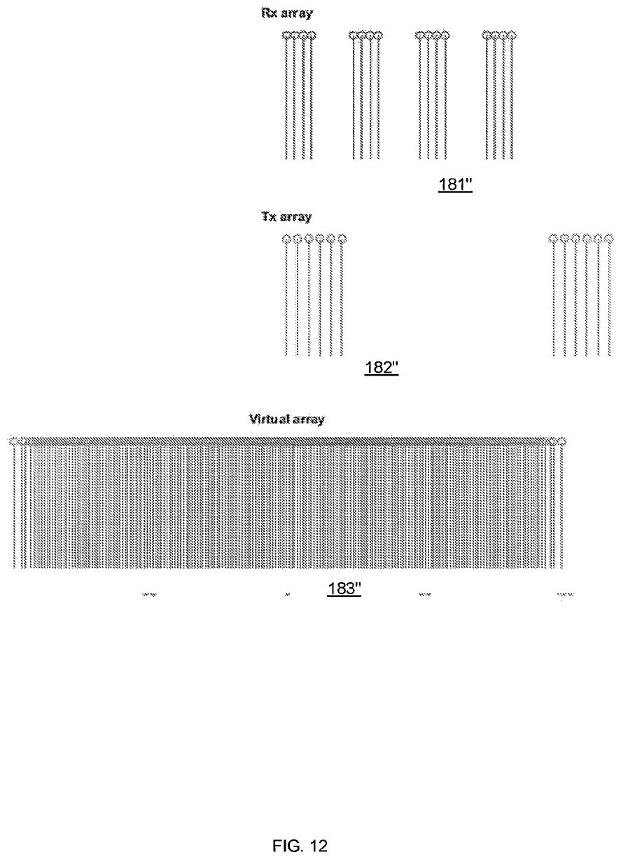

It should be noted that:
a. Several other combinations of segments/gaps may be provided for each of the {N_{RX}, N_{TX}, d_{R}, d_{T}} conditions. A good example for such a solution can be a sequence of “other-side matched groups” (as described in the rule b.), at one side, with 2 or more long groups at the other side. Am example for such a solution may be demonstrated in FIG. 12 hereafter. One, skilled in the art, may also use an extensive search to look for other possible solutions.

It may be convenient to generate a “regular” segment/gap sequence, though it may be not required.

There is a certain trade-off between amount of the segments and one-side antenna ambiguity suppression

Let us assume a Tx/Rx pair of MIMO antenna arrays spaced (coprime approach) 3 and 4 basic distance units (BDU).

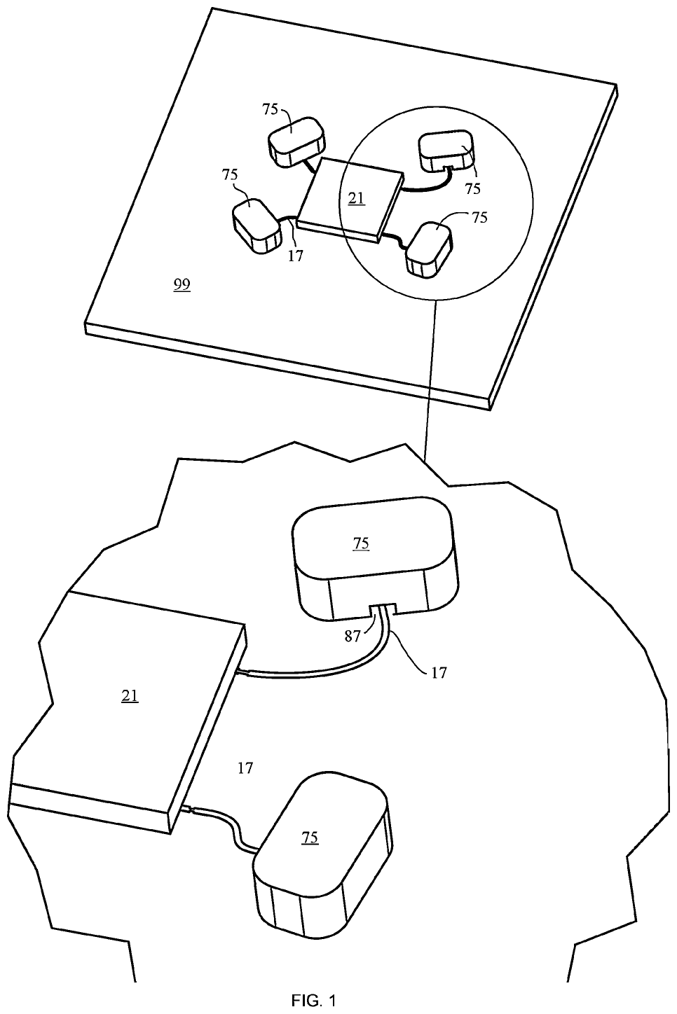

When the arrays grow beyond LCD(3,4)=12, a multiply defined virtual antennas appear. For example—referring to FIG. 1 0—a single group 181 of six transmission antennas and a single group 182 of eight reception antennas provide a virtual antenna array 183 (at a virtual antenna aperture) 3(8−1)+4(6−1)=41 or 3(6−1)+4(8−1)=43 virtual antennas.

However, with this design, several virtual antenna elements (at the center of the virtual array may be multiply defined), so when with use of “segmented coprime array” we can get much bigger aperture—see—FIG. 11. There may be two groups of reception antennas of a reception linear antenna array (LAA) 181′, and a single group of transmission antennas of a transmission LAA 182′ that provide a virtual array of antennas 183′.

FIG. 12 illustrates a reception LAA 181″ with four groups of four reception antennas each, and a transmission LAA 182″ with two groups of six reception antennas each. This may be an example of larger arrays—in which the gain (from using segmented coprime arrays) increases significantly, for example for the LAAs of FIG. 12, the amount of virtual antennas—and hence the size of the virtual aperture increases from about 100 to almost 200.

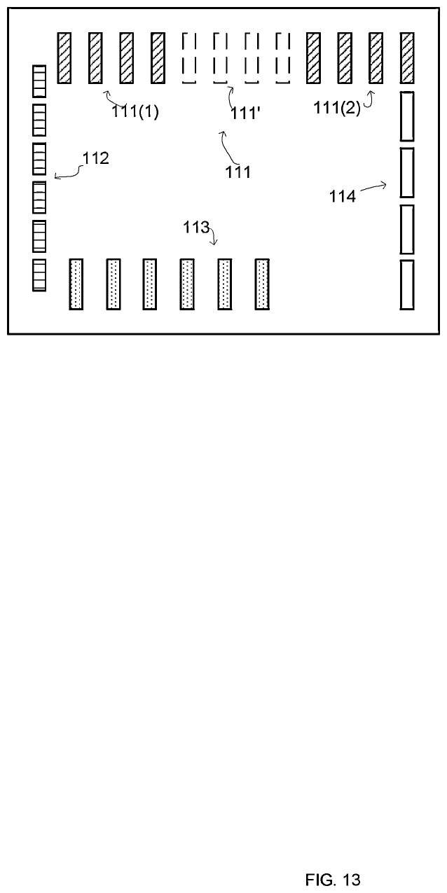

FIGS. 13-16 illustrates example of four LAAs—each may include one or more groups of antennas. The four LAAs includes first LAA 111, second LAA 113, third LAA 112 and fourth LAA 114. The first LAA and the third LAA form a first pair of reception and transmission LAAs. The second LAA and the fourth LAA form a second pair of reception and transmission LAAs.

In FIG. 13 the first LAA may be the only LAA that includes more than a single group of antennas—see first LAA groups 111(1) and 111(2) that may be spaced apart by a first LAA gap 111(9). FIG. 13 also illustrates the locations of four antennas 111′ that were not manufactured (omitted) to form the first LAA gap.

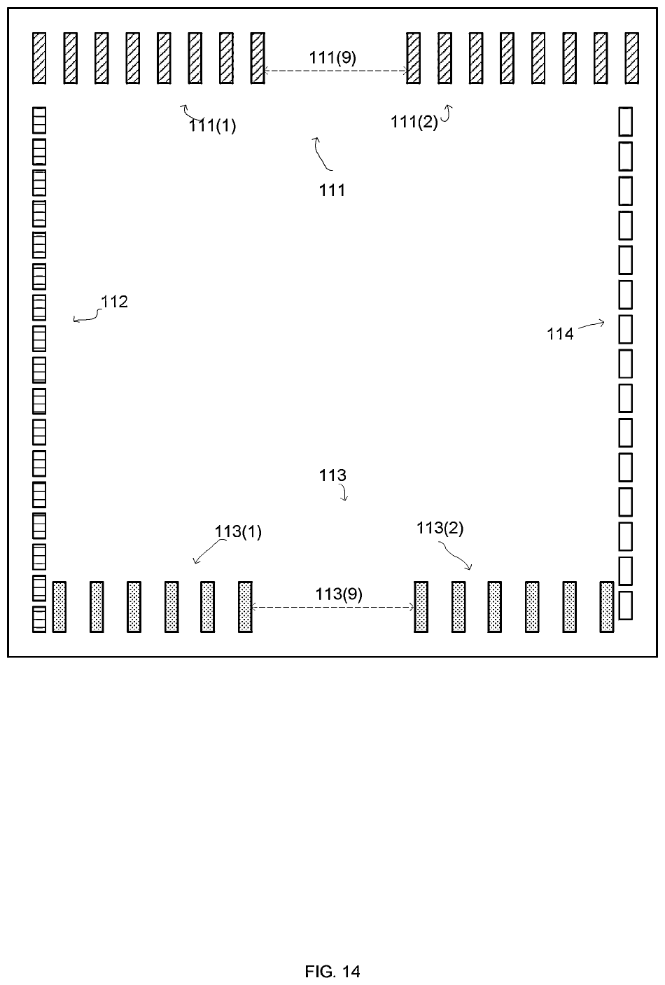

In FIG. 14 the first LAA includes first LAA groups 111(1) and 111(2) that may be spaced apart by a first LAA gap 111(9). Second LAA includes second LAA groups 113(1) and 113(2) that may be spaced apart by second LAA gap 113(9).

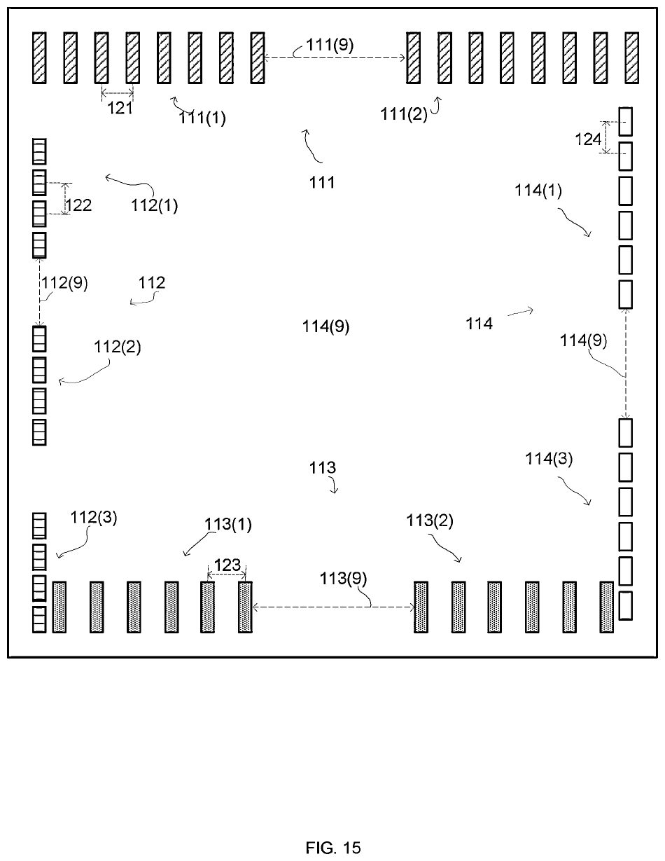

In FIG. 15 the first LAA includes first LAA groups 111(1) and 111(2) that may be spaced apart by a first LAA gap 111(9). Second LAA includes second LAA groups 113(1) and 113(2) that may be spaced apart by second LAA gap 113(9). Third LAA includes Third LAA groups 112(1), 112(2) and 112(3) that may be spaced apart by third LAA gap 112(9). Fourth LAA includes fourth LAA groups 114(1) and 114(2) that may be spaced apart by fourth LAA gap 114(9).

FIG. 15 also illustrates the distance (along a longitudinal axis of each LAA) between adjacent antennas (measured from the center of each antenna)—first distance 121 of first LAA, second distance 122 of second LAA, third distance 123 of third LAA, and fourth distance 124 of fourth LAA.

The first distance 121 may equal a first integer multiplied by a basic distance unit (related to the first pair of LAAs.) The second distance 123 may equal a second integer multiplied by the basic distance unit. The first integer and the second integer may be coprime integers. A number of first antennas of each group of the first LAA may be a multiple of the second integer. A number of second antennas of each group of the second LAA may be a multiple of the first integer. The first integer and the second integer may be coprime integers.

The third distance 122 may equal a third integer multiplied by a basic distance unit (related to the third pair of LAAs.) The fourth distance 124 may equal a fourth integer multiplied by the basic distance unit. The third integer and the fourth integer may be coprime integers. A number of third antennas of each group of the third LAA may be a multiple of the fourth integer. A number of fourth antennas of each group of the fourth LAA may be a multiple of the third integer. The third integer and the fourth integer may be coprime integers.

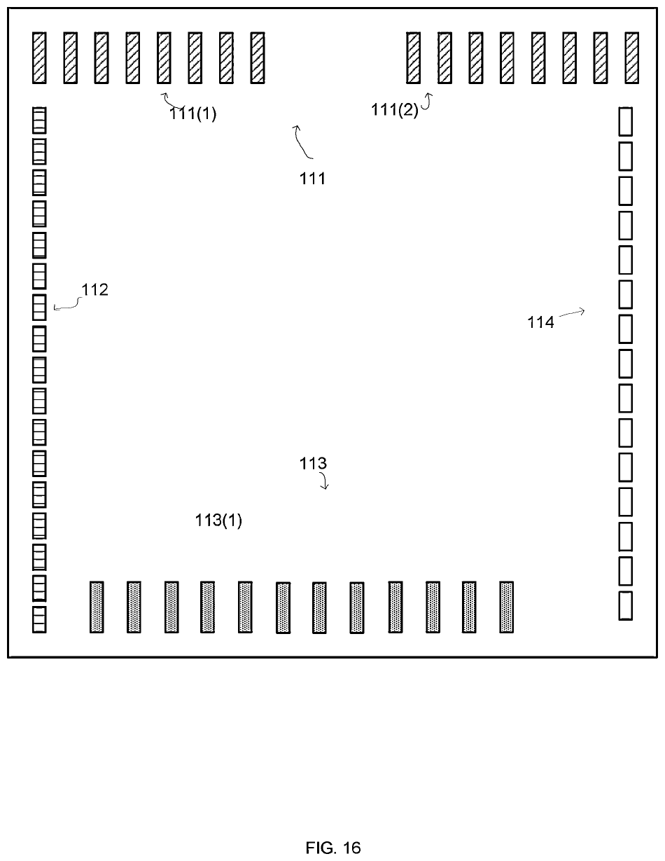

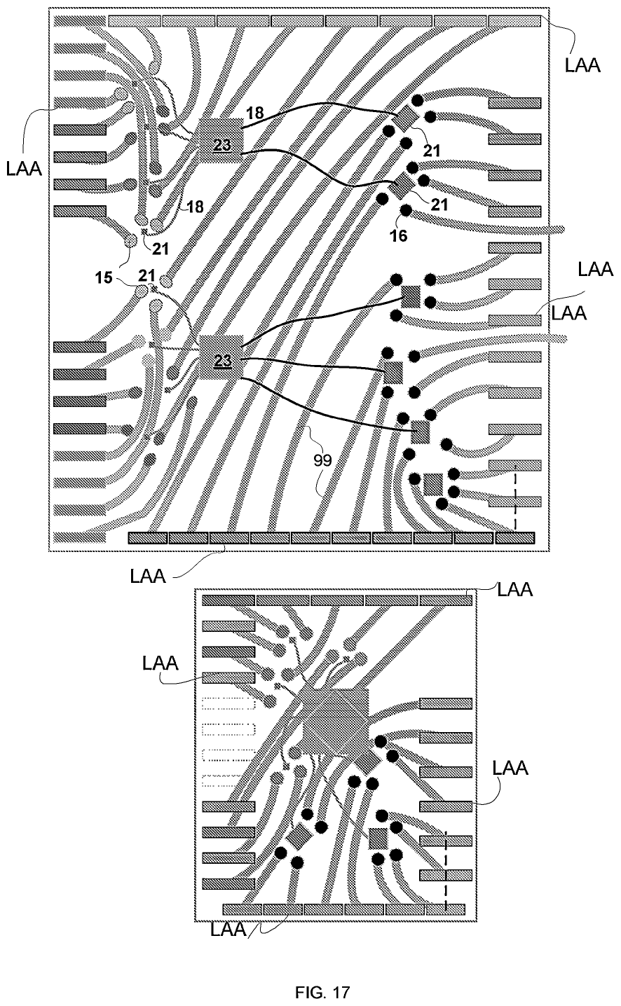

In FIG. 16 the first LAA may be the only LAA that includes more than a single group of antennas—see first LAA groups 111(1) and 111(2) that may be spaced apart by a first LAA gap 111(9).

FIG. 17 illustrates example of microstrips and other components of a MIMO radar.

There may be provided a MIMO radar that may include a first linear antenna array (LAA) that includes a group of first antennas that may be spaced apart from each other by a first distance. The first distance may equal a first integer multiplied by a basic distance unit.

The MIMO radar may also include a second LAA that may include groups of second antennas that may be spaced apart from each other by a second distance. The second distance may equal a second integer multiplied by the basic distance unit. The first integer and the second integer may be coprime integers.

A number of second antennas of each group of second antennas may be a multiple of the first integer. A number of first antenna of the group of first antennas may be a multiple of the second integer.

One LAA (of the first LAA and the second LAA) may be a transmission LAA. Another LAA (of the first LAA and the second LAA) may be a reception LAA.

The gap between adjacent groups of second antennas may exceed, by at least a factor of two, the second distance. A gap between adjacent groups of second antennas may be a multiple of the basic distance unit. A gap between adjacent groups of second antennas may differ from a multiple of the basic distance unit. A gap between adjacent groups of first antennas may exceed, by at least a factor of two, the first distance

The basic distance unit may equal half a wavelength of at least one signal transmitted by the transmission LAA.

The first LAA may include groups of the first antennas. A number of first antenna of each group of first antennas may be the multiple of the second integer.

The first LAA and the second LAA may be parallel to each other. The first LAA may be the transmission LAA and the second LAA may be the reception LAA. Alternatively—the first LAA may be the reception LAA and the second LAA may be the transmission LAA.

The MIMO radar may include a third LAA and a fourth LAA. The MIMO radar may include more than four LAAs.

The third LAA and the fourth LAA may be full and not segmented coprime arrays—that may consist a single group of antennas each.

The third LAA and the fourth LAA may be parallel to each other and may be oriented to each one of the first LAA and the second LAA.

The third LAA may include a group of third antennas that may be spaced apart from each other by a third distance. The third distance may equal a third integer multiplied by an additional basic distance unit. The fourth LAA may include groups of fourth antennas that may be spaced apart from each other by a fourth distance. The fourth distance may equal a fourth integer multiplied by the additional basic distance unit. The third integer and the fourth integer may be coprime integers.

A number of fourth antennas of each group of fourth antennas may be a multiple of the third integer. A number of third antennas of the group of third antennas may be a multiple of the fourth integer.

One LAA of the third LAA and the fourth LAA may be a transmission LAA and another LAA of the third LAA and the fourth LAA may be a reception LAA.

The additional basic distance unit may equal the basic distance unit.

The additional basic distance unit may differ from the basic distance unit.

The third LAA consists of a single group of antennas, and the fourth LAA consists of a single group of antennas.

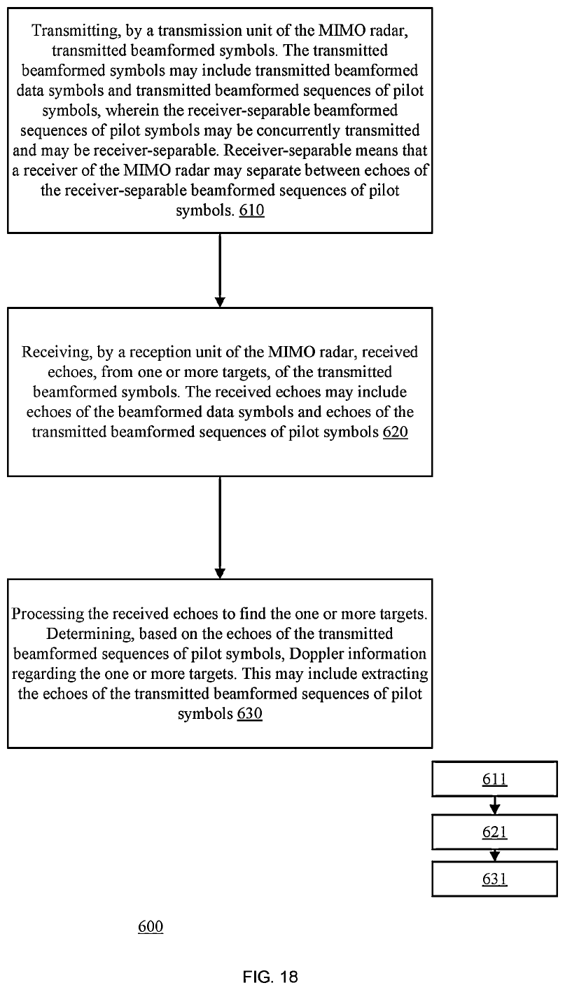

FIG. 18 illustrates an example of method 600 for operating a multiple input multiple output (MIMO) radar.

Method 600 may start by step 610 of transmitting transmitted RF signals by a transmission linear antenna array (LAA).

Step 610 may be followed by step 620 of receiving received RF signals by a reception LAA.

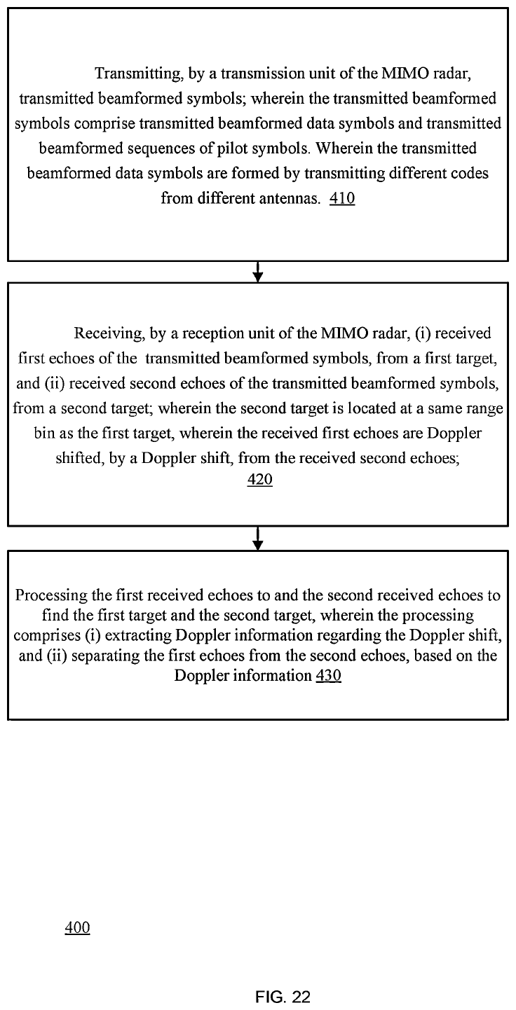

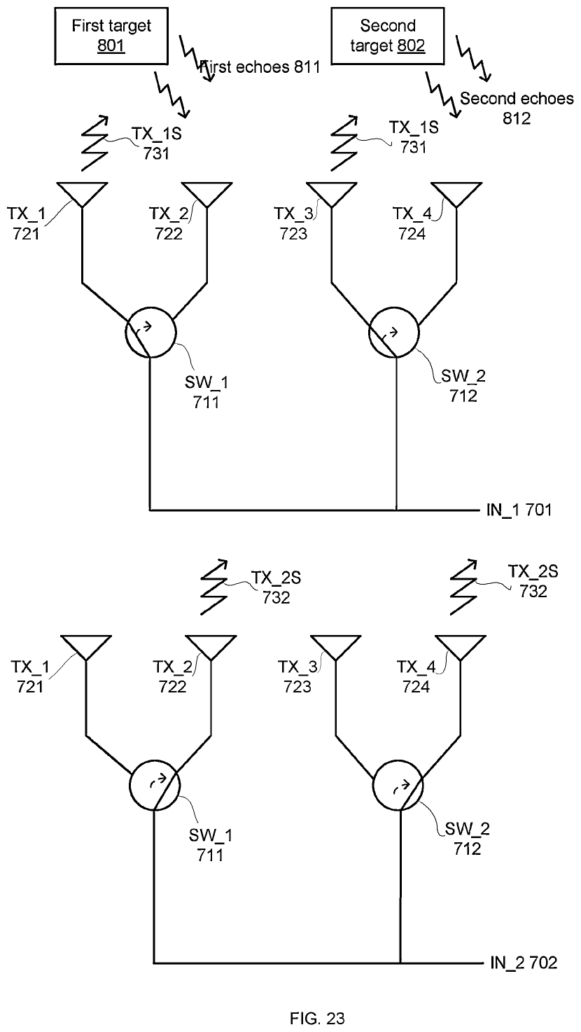

Step 620 may be followed by step 630 of processing the received RF signals. See, for example step 420 of method 400 of FIG. 22. Any other processing can be done.

One LAA of the transmission LAA and the reception LAA may include a group of first antennas that may be spaced apart from each other by a first distance; wherein the first distance may equal a first integer multiplied by a basic distance unit.

Another LAA of the transmission LAA and the reception LAA may include groups of second antennas that may be spaced apart from each other by a second distance; wherein the second distance may equal a second integer multiplied by the basic distance unit; wherein the first integer and the second integer may be coprime integers. A number of second antennas of each group of second antennas may be a multiple of the first integer. A number of first antenna of the group of first antennas may be a multiple of the second integer.

Method 600 may include transmitting through additional transmission antenna arrays and receiving through additional receiving antenna arrays. These transmissions and receptions may be executed concurrently with steps 610 and 620—or may be executed at non-overlapping time windows. If concurrently—beamforming may be formed by the additional transmissions and the transmissions of step 610.

If required—the additional transmissions may be received distinguishable from each other and from the transmissions of step 610.

For example—method 600 may include a step 611 of transmitting transmitted RF signals by another transmission LAA and receiving received RF signals by another reception LAA. Step 611 may be followed by step 621 of receiving received echoes—and by step 631 of processing. Any reference to steps 610, 620 and 630 may be applied, mutatis mutandis to steps 611, 621 and 631.

The other transmission LAA and the other reception LAA may be parallel to each other and may be oriented to each one of the transmission LAA and the reception LAA.

One LAA of the other transmission LAA and the other reception LAA may include a group of third antennas that may be spaced apart from each other by a third distance; wherein the third distance may equal a third integer multiplied by an additional basic distance unit.

Another LAA of the other transmission LAA and the other reception LAA may include groups of fourth antennas that may be spaced apart from each other by a fourth distance. The fourth distance may equal a fourth integer multiplied by the additional basic distance unit. The third integer and the fourth integer may be coprime integers. A number of fourth antennas of each group of fourth antennas may be a multiple of the third integer. A number of third antennas of the group of third antennas may be a multiple of the fourth integer.

The additional basic distance unit may or may not be equal to the basic distance unit.

### Transmission and Reception Schemes in a MIMO Radar

We like to generate MIMO radar, which means that the response from each Tx antenna to each Rx antenna should be measured. We assume here that FMCW radar may be used. Let us start from a simple case of one Tx antenna and one or more Rx antennas. Each Rx antenna may be assumed to be connected to Rx input of radar transceiver which include RF chain for each of the Rx channels. So all the Rx channels may be processed in parallel, independent of each other. On the Tx antenna we preferably transmit a sequence of chirps rather than one chirp. The reason may be that we which to measure the target Doppler frequency. The Doppler may be measured by the phase change in the Rx from chirp to chirp assuming that all the Tx chirps may be equal. So, without the Doppler effect all the Rx chirps would have been equal, the phase change along the chirps may be due to the Doppler effect if the object may be moving relative to the radar.

The radar signal processing starts with range FFT since using FMCW each target range corresponds to a different frequency. Each range FFT output may be called range bin and contains the response for a specific range. The range bin size in meters can be calculated from the chirp slope, FFT resolution, sampling frequency and other physical parameters.

Looking at a specific range bin from a sequence of chirps, we see the Doppler effect as exp(jωn) where n may be chirp index. It may be efficient to perform the Doppler estimation and separation between targets having different Dopplers using FFT, preferably after multiplying by a window (e.g. Kaiser window). The Doppler FFT resolution may be determined by the sequence length L and the chirp repetition frequency (CRF). The Doppler resolution in Hz can be calculated as CRF/L.

Translating Doppler frequency to velocity in m/s can be done using the Doppler equation

$$\\ {f}_{d} = \frac{2 v cos ( α )}{c} f$$

Where f may be the carrier frequency, v may be the target relative velocity, α may be the angle between the relative velocity direction and the target direction and c may be the speed of light.

The maximal Doppler frequency that can be estimated without ambiguity may be CRF. Ambiguities may be undesired so we wish to increase the unambiguous range as much as possible.

For a radar having more than one Tx antenna, there may be several ways to separate between Tx antenna transmissions.

TDMA—each Tx antenna may be transmitting alone, and the several antennas may be transmitting one by one. The drawback of TDMA may be a) we lose power since only one Tx may be used at a time b) Doppler unambiguous range may be reduced to CRF/Ntx.

DDMA—each Tx antenna may be assigned a different frequency offset, such that each chirp may be multiplied by a sequence exp(jωᵢn), where n may be the chirp number, i may be the Tx antenna index and ωᵢ may be the frequency offset. Now all Tx antennas may be transmitting in parallel and can be separated by the Doppler FFT. The drawback of this technique may be ambiguities between targets if their Dopplers differ by ωᵢ-ωⱼ, where i, j may be indexes of two antennas.

CDMA—each Tx antenna may be assigned a different code c_{i,n} of length L where n may be the chirp number, i may be the Tx antenna index. Each chirp may be multiplied by c_{i,n} Before transmission. It may be preferable to choose the code as orthogonal, i.e. for i≠j (assuming real code symbols)

$$\\ {\sum }_{n = 0}^{L - 1} {c}_{i , n} {c}_{j , n} = 0$$

The orthogonality of the codes allow for separation between Tx signals since correlation with other codes may be zero.

In the following example we use CDMA. When two or more targets may be present in the same range bin and these targets have two different Dopplers, these targets need to be separated. The codes may be no longer orthogonal so a solution using Least Squares (LS) may be used.

In order to formulate the LS equations, there may be a need to know the Doppler shifts of the targets per each range bin. In this invention we use pilots to estimate the dopplers. Pilot sequence may be a sequence of chirps which may be not multiplied by a code, so it enables the use of Doppler FFT. There may be many ways to include pilots in the frame.

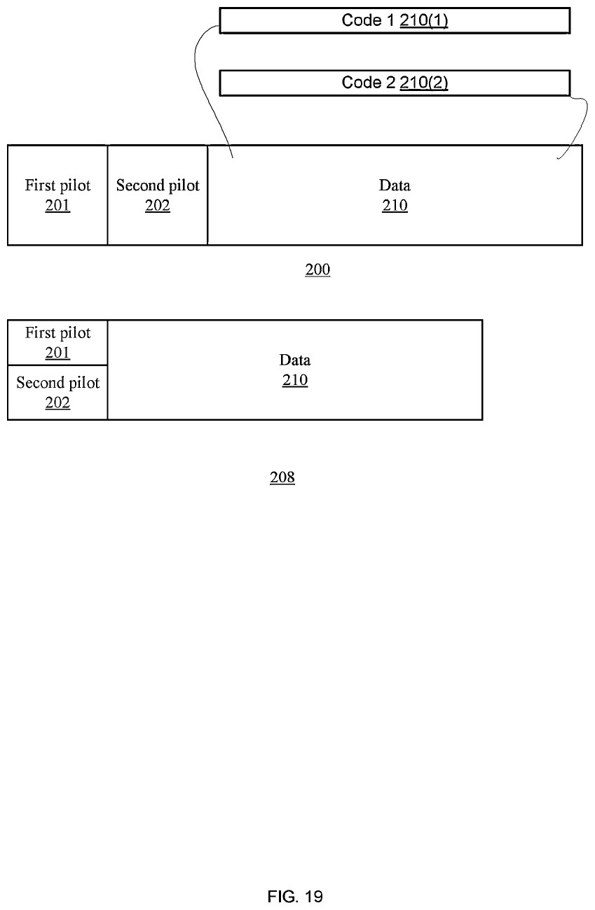

Referring to FIG. 19—which illustrates a frame 200 that includes a first pilot 201, a second pilot 202 that may be transmitted after the first frame, and data 210. The first pilot 201 may include a first sequence of first pilot symbols. The second pilot 202 may include a second sequence of second pilot symbols.

Another example of a frame includes frame 208 that includes concurrently transmitted first pilot 201 and second pilot 202 followed by data 210.

The number of pilots per frame may differ from two—may be one, three or more. The data and the pilots may be interleaved. The data may be transmitted before any of the pilots, and the like.

Note that a different number of pilots can be used, or a pilot may not be used at all (frame skipped), and the target Dopplers will be interpolated between the pilots present.

Each pilot sequence may be composed from a repetition Lp times of same chirp signal. Each Tx antenna that may be used during the pilot may be transmitting after applying phase shift in hardware, so if more than one Tx antenna may be used, some beamforming may be generated. We wish to create such beamform that illuminate the desired FOV evenly.

The first and second pilots may differ only in the phases used so the beamforming of the first and second pilots. The phase shifts may be designed in such a way that if one of the pilots has a notch in a direction, the other pilot will not have a notch in this direction. It may be beneficial that the average (over time) of the beamformed signals will be constant along the entire FOV or at least over a majority of the FOV.

The ability to create a beamform that illuminates evenly the field of view may be hardware dependent. In some radar configurations it may be possible to make a good beamform using one pilot. In other hardware configuration it may be not possible to create a beamform that covers the FOV evenly and so it may be preferred to use two or more pilots with different beamforming as noted above.

In case there may be only a binary phase shifter (0/180) in the hardware, it may be easier to obtain uniform or almost uniform coverage over at least a majority of the FOV using a combination of two more beamforming elements—that together cover the whole FOV. The important parameter may be the maximal gain over all pilots, and taking the minimum of this maximum over all angles. The search will seek for maximal such minimum.

In case there may be a full phase shifter it may be possible to find two beamforms by design.

The following example illustrate two triplets of antennas that may be allocated to perform first pilot beamforming and second pilot beamforming—for example at the following configuration—BF=[(0°&30°@-60°&60°@60°&-90°)]—meaning that the first three antennas that transmit the first sequences of pilot symbols may be in relative phases of 0⁰, −60⁰ and 60⁰, and the second three antennas that transmit the second sequences of pilot symbols may be in relative phases of 30⁰, 60⁰ and −90⁰, respectively.

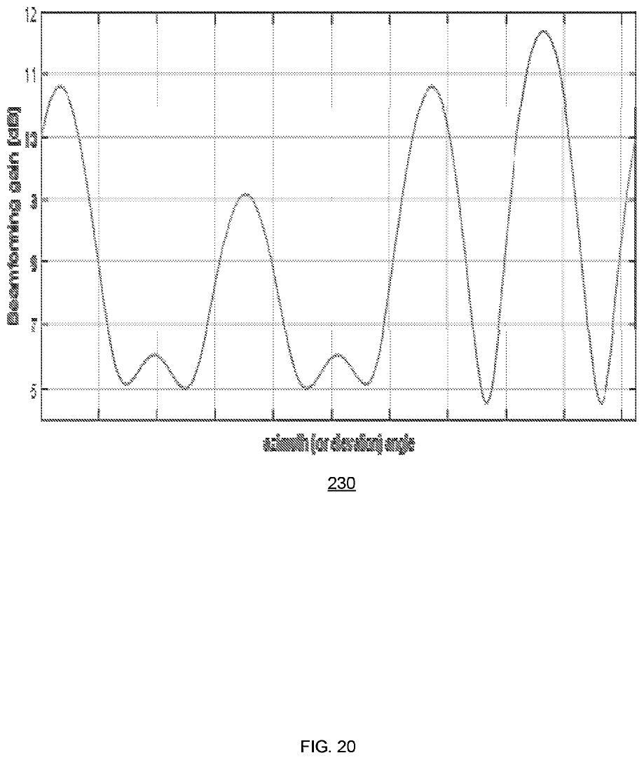

FIG. 20 depicts the proposed pilot BF. The total (energy sum BF may be flat). I.e. energy sum of the BFs may be constant and may be equal precisely to 10log₁₀(6)=7.8 dB.

This beamforming may be not omnidirectional, and the maximal loss may be approximately 2.6 dB relative to the expected average.

Another option may be using a vertical array for the pilots and create a beamform that spans the required FOV in the elevation.

It should be noted that either vertical or horizontal antenna arrays can be used for that.

Note that repeating same pilot (first pilot or second pilot) in the frames allows for phase and frequency interpolation so that the phase and frequency of the Doppler per target will be more accurate at the region of CDMA Each CDMA region has at least one pilot before it and at least one after it.

An algorithm as an example may be the following. Take one pilot before the CDMA and one pilot after it. Those pilots have to be identical (first pilot and first pilot) or (second pilot and second pilot). Take this pilot pair and perform an FFT on a signal containing both pilots. After peak search in the FFT the frequency and phase may be found for the pair.

Now since the CDMA portion may be not exactly in the middle between the two pilots in the pair, the phase has to be corrected to the right location using the found frequency. Moreover, tracking frequency slopes allows for estimation acceleration. One such algorithm involved taking the local peaks of the FFT of each pilot. During the clustering operation for assigning peaks with targets, frequency slope may be also allowed. Frequency slope indicates acceleration in the real life or angle change.

Assuming a transmission using a first set of three antennas and a second set of second antennas.

Pilots may be adjacent to data part (CDMA) before, in the middle (some part of data before pilots and some after) or after it. Alternatively, symbols of pilots may be interleaved with data part. For example, even chirps may be pilots and odd chirps may be data.

There may be a gap between frames, where a frame may be composed of pilot(s) and data.

There may be an option of using two (or more) pilots via DDMA. Instead of transmitting the pilots one after the other we can save transmission time and send two (or more) pilots together in one sequence of chirps using DDMA. In DDMA, several sequences of symbols may be shifted in the Doppler domain and transmitted on different antennas.

For example—in the previous example we generated two pilots, one with antennas 1,2,3 and the other on 4,5,6. The DDMA frequency shift may be chosen to PRF/2 where PRF may be the chirp repetition frequency.

So, at antennas 1,2,3 we transit with phase shifts [0,−60,60] respectively. At antennas 4,5,6 we transmit with alternating phases—with a phase shift of (180n+[30,60,−90]), where n may be the chirp serial number. Note that a phase shift of 180n may be equivalent to a frequency shift of half the sampling rate, which may be the prf.

This technique may generate a doppler ambiguity with magnitude half of the previous doppler ambiguity. This ambiguity can be easily solved—for example by using pilots with varying PRFs (the PRFs change from one frame to another).

Note that the separation between the antennas that generate the beamforming for the pilots need not necessary be lambda/2, where lambda may be the wavelength. When separation may be larger than lambda/2 grating lobes will occur. But this only creates repetition of the same beamforming shape, with no change of the received power of the worst angle in the range.

Another option may be using one pilot. In this case a beamforming set need to be found to maximize the worst-case angle. A numerical search leads to the following beamforming set on an array of seven antennas [0, 11, 15, 11, 10, 1, 1]* 360/16.

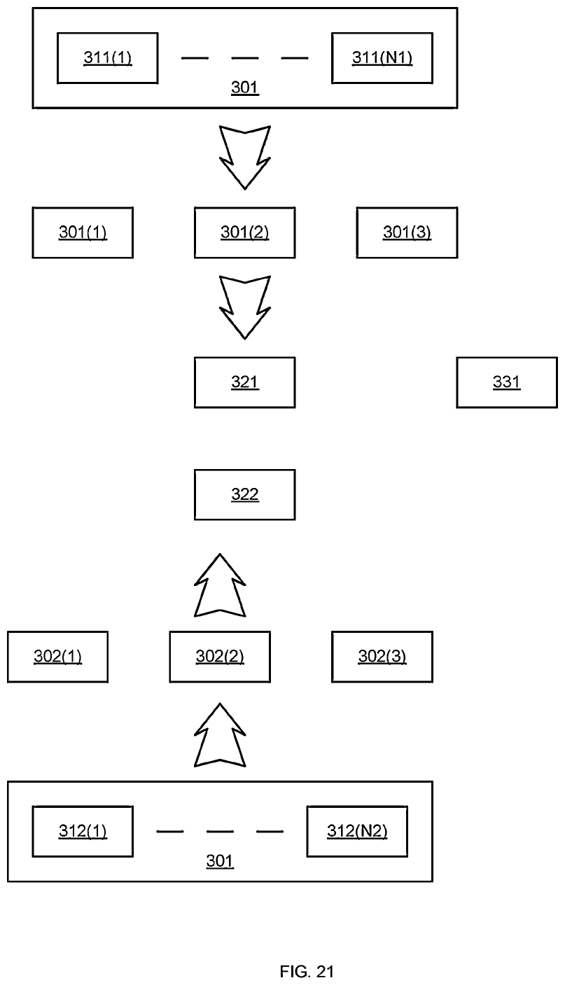

FIG. 21 illustrate various signals.

The various signals include a first 301 sequence of symbols 311(1)-311(N1), first three phase shifted (in relation to each other) versions 301(1), 301(2) and 301(3) of the first sequence of signals, first beamformed signals 321 formed by the concurrent transmission of the first three phase shifted versions by three first transmission antennas 331(1), 331(2) and 331(3).

The various signals also include a second 302 sequence of symbols 312(1)-312(N2), three second phase shifted (in relation to each other) versions 302(1), 302(2) and 302(3) of the second sequence of signals, second beamformed signals 321 formed by the concurrent transmission of the second three phase shifted versions by three second first transmission antennas 332(1), 332(2) and 332(3).

FIG. 22 illustrated method 400 method for target detection using a multiple input multiple output (MIMO) radar.

Method 400 may start by step 410 of transmitting, by a transmission unit of the MIMO radar, transmitted beamformed symbols; wherein the transmitted beamformed symbols comprise transmitted beamformed data symbols and transmitted beamformed sequences of pilot symbols, wherein the transmitted beamformed data symbols are formed by transmitting different codes from different antennas;

The pilot sequences may be concurrently transmitted.

The pilot sequences may be serially transmitted.

The transmission may cover a field of view FOV.

The frequency shift between the beamformed sequences may be half a pilot repetition rate of the pilot symbols of the transmitted beamformed sequences of pilot symbols.

The pilot symbols may be chirps.

Step 410 may include transmitting, through first transmission antennas of the transmission unit, phase shifted versions of pilot symbols of a first sequence of pilot symbols to provide first transmitted beamformed pilot symbols.

Step 410 may include transmitting, through second transmission antennas of the transmission unit, phase shifted versions of pilot symbols of a second sequence of pilot symbols to provide second transmitted beamformed pilot symbols.

Step 410 may include or may be preceded by phase shifting the pilot symbols of the first sequence to provide the phase shifted versions of the first sequence, and phase shifting the pilot symbols of the second sequence to provide the phase shifted versions of the second sequence.

The pilot symbols of the first sequence may be of a same phase, and pilot symbols of the second sequence may be of alternating phase.

The pilot symbols of the first sequence have phases that may be orthogonal to phases of the pilot symbols of the second sequence.

The phase shifted versions of the first sequence may be phase shifted by zero degrees, minus sixty degrees and sixty degrees respectively, and wherein the phase shifted versions of the second sequence may be phase shifted by thirty degrees, sixty degrees and minus ninety degrees, respectively.

The first transmission antennas may include at least three first transmission antennas, and wherein the second antennas may include at least three second transmission antennas.

The first transmission antennas and the second transmission antennas belong to a linear array of antennas.

The first transmission antennas may include at least three first transmission antennas, and wherein the second antennas may include at least three second transmission antennas.

Step 410 may include transmission, through one of the first transmission antennas, of one of the phase shifted versions of the pilot symbols of the first sequence—in order to compensate for transmission gaps of a transmission, through another one of the first transmission antennas of another one of the phase shifted versions of the pilot symbols of the first sequence.

Step 410 may include transmission, through the other one of the first transmission antennas, of the other one of the phase shifted versions of the pilot symbols of the first sequence—in order compensates for transmission gaps of the transmission, through the one of the first transmission antennas of the one of the phase shifted versions of the pilot symbols of the first sequence.

Step 410 may include transmitting the transmitted beamformed symbols in frames, wherein each frame may include transmitted beamformed sequences of pilot symbols and transmitted beamformed data symbols.

The pulse repetition rate of the transmitted beamformed pilots may be constant within a single frame.

The pulse repetition rate of transmitted beamformed pilots of one frame differ from the pulse repetition rate of transmitted beamformed pilots of another frame.

Step 410 may include transmitting from different antenna different codes. The codes may be orthogonal to each other. The codes may differ from each other while not being orthogonal to each other.

Step 410 may be followed by step 420 of receiving, by a reception unit of the MIMO radar, (i) received first echoes of the transmitted beamformed symbols, from a first target, and (ii) received second echoes of the transmitted beamformed symbols, from a second target; wherein the second target is located at a same range bin as the first target, wherein the received first echoes are Doppler shifted, by a Doppler shift, from the received second echoes.

The same range bin may include a predefined distance sub-range from each other.

Step 420 may be followed by step 430 of processing the first received echoes to and the second received echoes to find the first target and the second target, wherein the processing may include (i) extracting Doppler information regarding the Doppler shift, and (ii) separating the first echoes from the second echoes, based on the Doppler information.

Step 430 may include extracting the Doppler information from the beamformed data symbols.

Step 430 may include extracting the Doppler information from the pilot symbols.

The separating may include applying a Least square errors separation algorithm—or another algorithm.

Step 430 may include phase separating the beamformed sequences of pilot symbols.

Step 430 may include code separating the beamformed sequences of pilot symbols. For example applying a CDMA process.

Step 430 may include frequency separating the beamformed sequences of pilot symbols.

It should be noted that a single MIMO radar may implement methods 400 and 600. It should be noted that a single MIMO radar may implement only of methods 400 or 600.

It should be noted that any combination of transmission antennas of any of the transmission LLA of any one of FIGS. 9 till 17 may be used for the transmission of step 410 of FIG. 18. It should be noted that any combination of reception antenna of any of the reception LLA of any one of FIGS. 9 till 17 may be used for the reception of step 420.

### Concurrent Usage of Different Modes of a Radar

Let us assume that we have two modes of radar operation which we like to use concurrently. For example, suppose we have two sets of RX antennas which are connected to the same set of RX channels from the RX antennas—which provide inputs of the radar.

For example, let us have a linear array of antennas having 2N elements and a radar hardware with N inputs. Each input has a RF chain. There is an analog switch or multiplexer (mux) with two inputs and one output that can direct a set of N antennas out of the 2N antennas toward the N_{RX} channels by a digital command. Since we want the data from 2N antennas concurrently we want to interleave two codes where each of the two codes is used with one mux state.

For example, if state 1 and state 2 denote multiplexer states—the MIMO radar can transmit a sequence of chirps, where in each chirp the MIMO radar transmits using all concurrent transmission channels, each with its own code. The sequence may look like 1 1 2 1 2 2 2 1 2 1 . . . the codes are thus interleaved in time.

This pseudo random interleaving is advantageous for reducing the probability of high correlation between codes shifted by two doppler shifts from two targets. This interleaving additional advantage is that the time duration for transmitting a code is increased by two so doppler sensitivity in increased by two. The number of radar states may be higher than two. The radar states might involve change of which antennas are transmitting.

The LS (least squares) solution computation is a complexity heavy mathematical operation so there is provided a solution that may reduce the number of LS calculations. The LS equations are based on a specific placement of code symbols in time. If the stated time sequences are different, then for each code state the LS solution computation needs to be recalculated. The solution interleaves two sequences with identical time separation for using one LS calculation for both. In general, in each state a different code is used but for this example the same code may be used in all states.

The solution may use two identical pseudorandom sequences in forward and backward direction. When the sequence is inverted in time the doppler shift effect is identical, only conjugated. (e^{jwt} is a conjugate of e^{-jwt}). Accordingly—after the LS solution is obtained for the backward sequence we apply conjugate on the result. Here is an example of such sequence: 2 1 1 2 2 1 2 1 1 2 2 1

The locations of the state 1 in this sequence are 2, 3, 6, 8, 9, and 12.

The locations of the state 2 in this sequence, looking from end to start are 2, 3, 6, 8, 9, and 12.

Another way could be to use a half-way cyclic shift between the two sequences instead of time-reversal (forward/backward). Here is an example of 2 time-shifted interleaved sequences: 1 2 1 2 2 1 2 1 2 1 1 2

The locations of the state 1 in this sequence are: 1, 3, 6, 8, 10 and 11

The locations of the state 2 in this sequence, counting in a cyclic fashion from the middle of the sequence are: 1+6, 3+6, 6+6, 8−6, 10−6, 11−6, which is precisely a cyclic shift (modulo−12) of the 1^{st} sequence 1, 3, 6, 8, 10, 11.

It is also possible to extend this technique to more than two interleaved sequences, e.g., by use of the forward-backward and the cyclic-shift interleaving techniques, as presented here beforehand, together at the same time. This way a 4-fold computation simplification can be achieved.

FIG. 23 illustrates a four transmission antennas TX_1 721, TX_2 722, TX_3 723 and TX_4 724, two switches SW_1 711 and SW_2 712, each switch in communication with two transmission antennas.

The upper part of FIG. 23 illustrate the switches in a first state—in which they feed TX_1 721 and TX_3 723 with code symbols TX_1S 731 of a first pseudo random symbol sequence (PRSS).

The lower part of FIG. 23 illustrate the switches in a second state—in which they feed TX_2 721 and TX_2 723 with code symbols TX_2S 732 of a second PRSS.

The second pseudo random symbol sequence is a manipulated version of the first PRSS. The manipulation may include ordered inversion (backwards instead of forward), any cyclic shift or a combination thereof. Various examples are illustrated above.

The interleaved transmission of the first PRSS and the second PRSS enables to separate (for example using LS) echoes from two targets located at the same range bin—and exhibit different Doppler shifts. Once calculating the first mapping between the received echoes from the first target to the first transmitted code—a second mapping between the received echoes from the second target to the second transmitted code can easily calculated—as it is a conjugate of the first mapping.

### Example of MIMO Radar

Any of the mentioned above methods may be executed by the MIMO radar illustrated below and in FIGS. 1-8. Any of the mentioned above methods may be executed by another MIMO radar. Any MIMO antenna arrays and/or processor and/or any other component may be a part of the MIMO radar illustrated below and in figured 1-8. Any MIMO antenna arrays and/or processor and/or any other component may be a part of a MIMO radar other than the MIMO radar illustrated below and in figured 1-8.

There may be provides an RF radar that may include a radome, a single bulk in which RF antenna arrays and portions of waveguides may be formed, a printed circuit board (PCB) that supports an RF circuitry, a lower-than-RF-frequency circuitry; and a back portion.

For simplicity of explanation may be assumed that the radome may be located at front of the radar. The side of the single bulk that faces the radome may be referred to as a front side of the bulk. The side of the single bulk that faces the PCB may be referred to as a back side of the single bulk. The side of the PCB that faces the single bulk may be referred to as a front side of the PCB. The side of the PCB that faces the back portion of the radar (for example faces a heat sink) may be referred to as a rear side of the PCB.

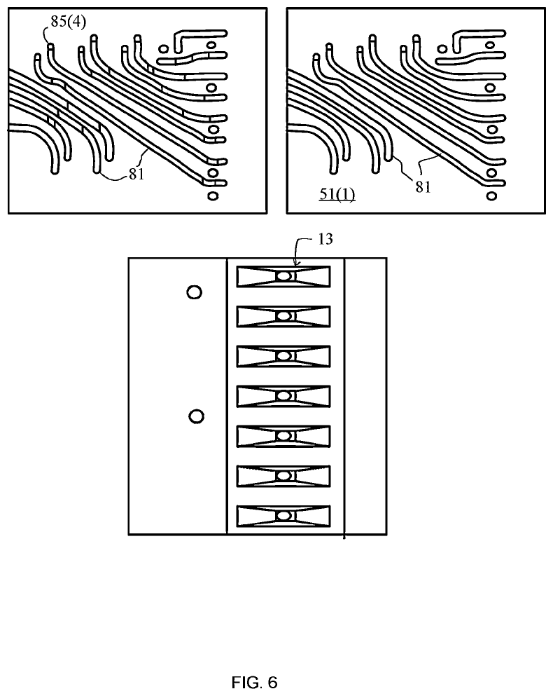

FIG. 1 illustrates the rear side 99 of the PCB and various RF components—including a switch (such as received switch—RX switch 21) that may be part of a reception path, may be a part of a transmission path or may be part of both. Microstrips 17 convey RF signals between the RX switch 21 and four waveguide to microstrip transitions 75. Any number of waveguide to microstrip transitions may be provided. The RX switch 21 (as well as transmission switches—denoted TX switch 22 in FIG. 5) may be used for allocating multiple antennas per channel.

A microstrip 17 enters a waveguide to microstrip transition 75 via an opening 87 formed in the waveguide to microstrip transition 75.

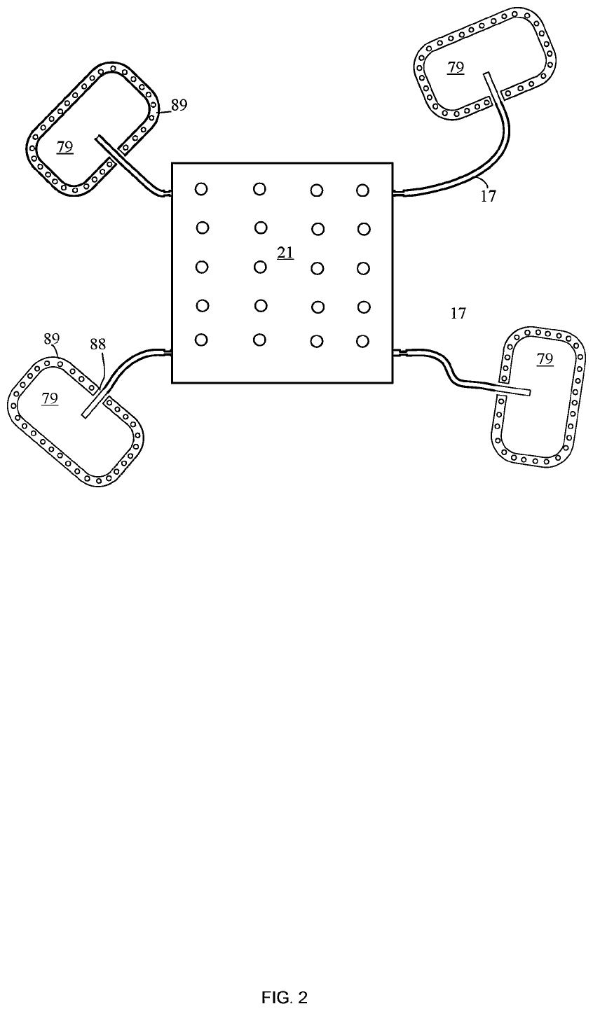

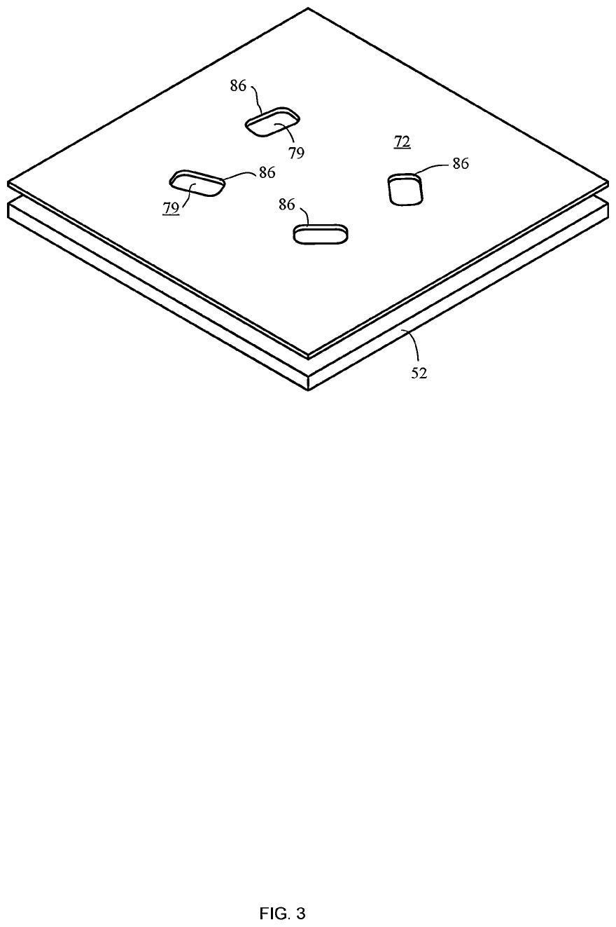

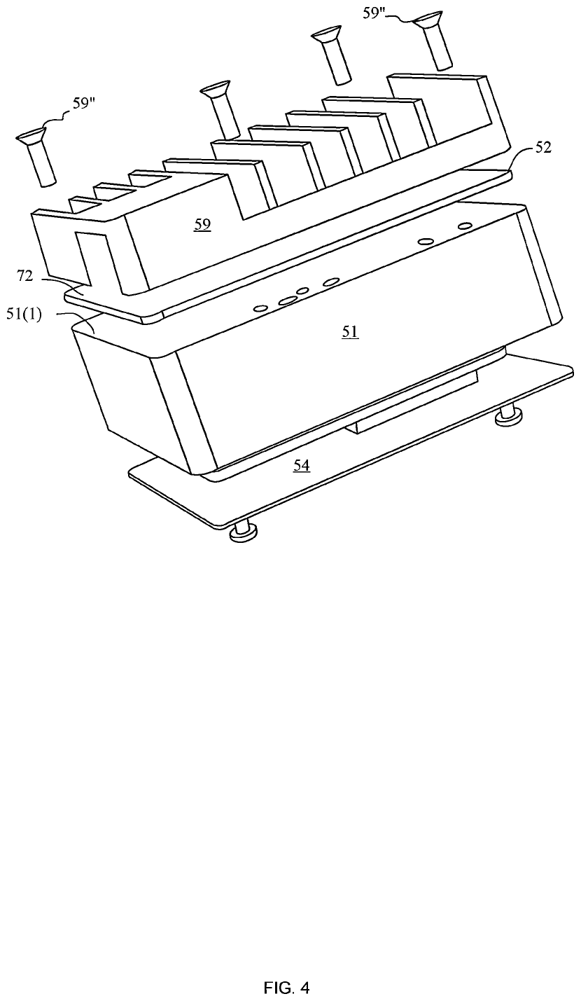

FIG. 2 illustrates a part of the rear side of the PCB without the waveguide to microstrip transitions. Sidewalls of the waveguide to microstrip transitions may be positioned on a conductive frame 89 that has a gap 88—that corresponds to opening 87. A microstrip that enters through the opening gap 88 and opening 87 may be mechanically supported by dielectric layer 79 that terminates cavities that pass through the PCB. The cavities may be denoted 86 in FIG. 3. FIG. 3 also illustrates a conductive plate 52 that may form one or more covers to one or more waveguides. The covers may be example of complementary portions of the waveguides.

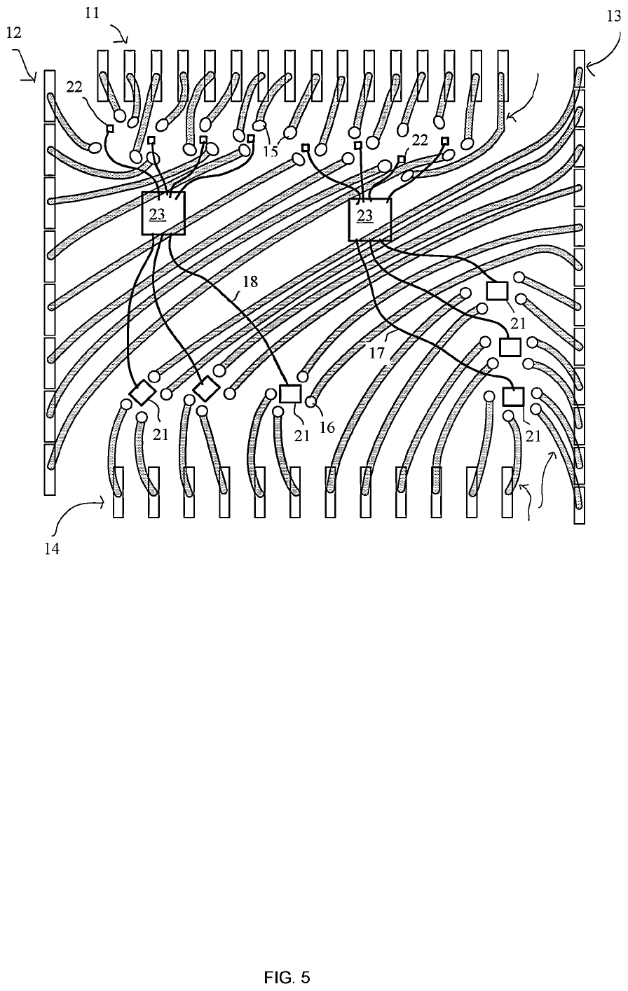

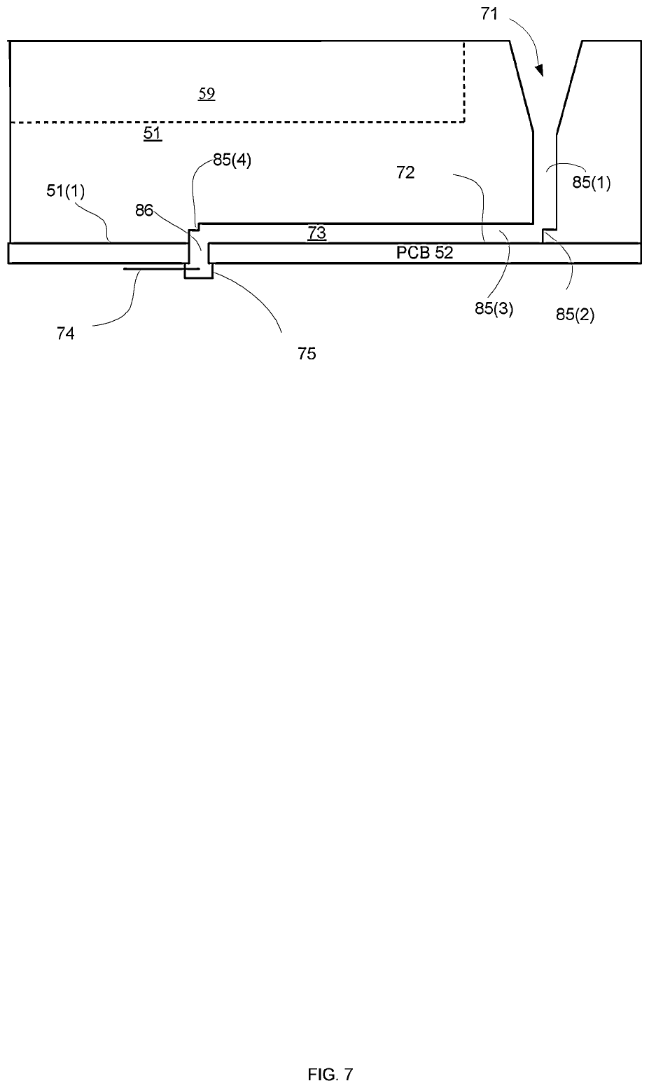

Referring to FIG. 4—the radar 50 may include (i) a radome 54 that precedes RF antenna arrays, (ii) one or more structural elements such as single bulk 51 in which both RF antenna arrays and waveguides may be at least partially formed, (iii) PCB 52, (iv) a back portion that may include one or more heatsinks 59, and (v) one or more additional components 58 such as a LIDAR, a camera, any other sensor, any electrical and/or optical and/or RF circuits that may be located within an inner space formed in the front side of the one or more structural elements—the inner space (denoted 57 in FIG. 7) may be formed between the different antenna arrays. The heatsink may be fastened to the structural element 51 by fastening elements 59″. FIG. 4 may be an exploded view of the radar and thus the one or more additional components 58 may be located at least in part between the radome and the one or more structural elements.

The RF PCB may support monolithic microwave integrated circuits (MMIC) chips that operate in RF frequency and/or may support lower-that-RF frequency chips. The lower-than-RF frequency chips may operate at baseband and/or other lower frequency. Alternatively, the lower frequency chips may be located on another PCB (also referred to as digital PCB″).

FIG. 5 illustrates some layers of the radar.
a. First TX antenna array 11, a second TX antenna array 12, a first RX antenna array 13 and a second RX antenna array 14 pass through a part of the single bult and extend through the front side of the single bulk.
b. Various sets of waveguides may be formed by cavities located within the rear side of the single bult and by complementary portions formed on the front side of the PCB.
c. Microstrips, waveguide to microstrip transitions, and RF circuitry (switches, RX/TX chips) may be formed (at least mostly formed) on the rear side of the PCB.

The first TX antenna array 11, second TX antenna array 12, first RX antenna array 13 and second RX antenna array 14—located (when virtually looking at the front side of the single bulk) at a top facet, left facet, low facet and right facet of the support unit, respectively.

The first TX antenna array 11 may be coupled via a first set of waveguides 31 to waveguides to TX waveguide to waveguide to microstrip transition15. The second TX antenna array 12 may be coupled via a second set of waveguides 32 to waveguides to TX waveguide to waveguide to microstrip transition15.

The first RX antenna array 13 may be coupled via a first set of waveguides 33 to waveguides to RX waveguide to waveguide to microstrip transition16. The second RX antenna array 14 may be coupled via a second set of waveguides 34 to waveguides to RX waveguide to waveguide to microstrip transition16.

The RX waveguide to waveguide to microstrip transition16 may be coupled via microstrips (not shown) to RX switches 21.

The TX waveguide to waveguide to microstrip transition15 may be coupled via microstrips (not shown) to TX switches 22.

RX switches 21 may be coupled via microstrips 18 to RX/TX chips 23.

TX switches 22 may be coupled via microstrips 17 to RX/TX chips 23.

The waveguides do not cross each other—and may be located at a same plane—for example—their cavities may be located at a rear plane of the single bult.

The module illustrated above may be configured to use RX and/TX antenna array subsets—as each antenna may be coupled to a dedicated waveguide and multiple waveguides and/or microstrips coupled to waveguides may be fed to RX and/or TX switches. A subset of antennas may include a consecutive set of antennas and/or non-consecutive set of antennas.

Any RF switch may be passive or active. For example—the TX switches may be active while the RX switches may be passive. Any RF switch may include signal amplification. A splitter with or without amplification and/or phase shifter can be used instead of any TX switch. A combiner with or without phase shifter and/or amplification can be used instead of any RX switch.

FIG. 6 illustrates a some cavities 81 formed in the back side 51(1) of the single bulk and also illustrated first RX antenna array 13 that extend from a frond side of the single bulk.

FIG. 7 illustrates cross section of a part of structural element 51 in which horn antenna 71 and waveguide 73 may be formed. The part does not include a horn antenna of an opposite antenna array. The part illustrated (dashed line) a part of the inner space 57 formed at the front side of the single bulk 51—and may be of any depth—for example 10, 20, 30, 40, 50, 60, 70, 80 percent of the height of the single bulk.

The waveguide starts by a vertical to horizontal transition 85(4) (for example a knee formed by a part of a cavity formed in the single bulk), that may be followed by a horizontal section 85(3) of the waveguide, that may be followed by a horizontal to vertical transition 85(2), that may be followed by a vertical section 85(1) of the waveguide. The vertical section 85(1) of the waveguide leads to the horn antenna 71.

The horizontal section may spang along a majority of the waveguide but any other relationship between the lengths of different sections of the waveguide may be provided.

The vertical to horizontal transition 85(4) may be preceded by a cavity 86 that passes through the PCB that may be preceded by a waveguide to microstrip transition 75. FIG. 7 also illustrates a microstrip 74.

Some of the waveguide (For example—the vertical sections—or any other section—immediately preceding or following the horn antenna) may be completely formed within the structural element and some other parts of the waveguide—for example—the horizontal section or any section that precedes the waveguide to microstrip transition) may be partially formed by the structural element.

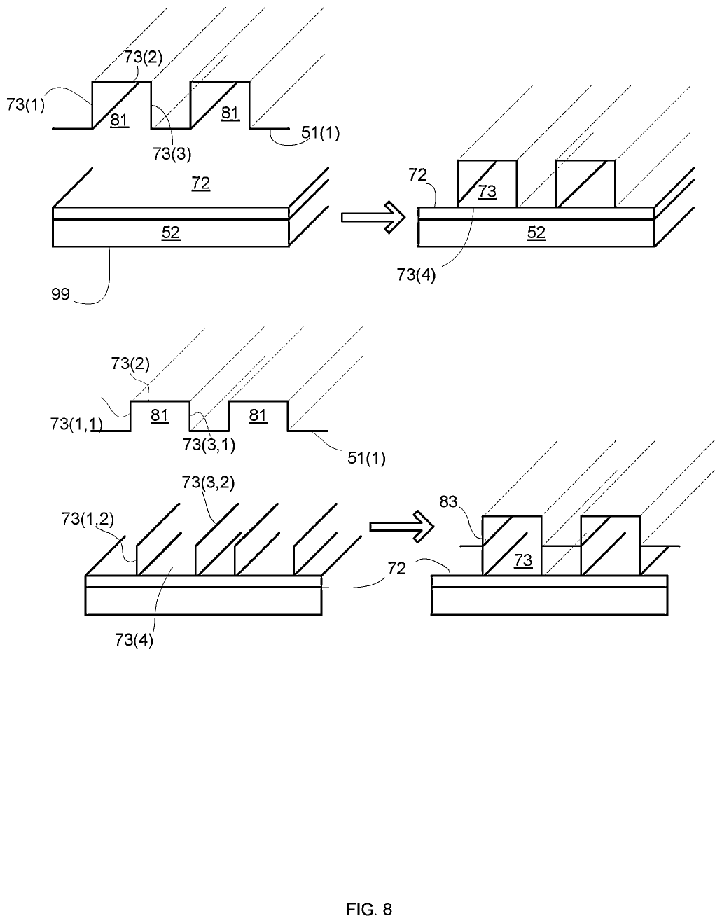

FIG. 8 illustrates two examples of forming waveguides.

According to a first example (shown at the upper part of FIG. 8) illustrates that three facets (73(1), 73(2) and 73(3)) of a rectangular waveguide may be sidewalls of cavities 81 formed in the rear side of the bulk—and that fourth facet 73(4) if formed by a conductive plate 72 formed on the front side of the PCB 52. The rear side 99 of the PCB may be also shown.

According to a second example (shown at the bottom part of FIG. 8)—one facet (73(2)) of the waveguide may be formed by cavity 81, one other facet (73(4)) of the waveguide may be formed by the conductive plate 72, a first parts (73(1,1) and 73(3,1)) of two additional facets may be formed by cavity and second parts (73(1,2) and 73(3,2)) of the two additional facets may be formed by conductive elements that extend from the PCB.

It has been found that forming the waveguides (for example by welding) may be easier when using the second example—as the contact points (see welding line 83) may be limited to the width of the segmented facets of the waveguide.

It should be noted that horn antennas (shown in various figures) may be replaced by another type of antenna—such as Printed microstrip antenna (PCB), Antenna on package. It has be found that the horn antenna provides good performance in terms of Wide bandwidth, High efficiency, High accuracy of production, matching between different elements, and Wide or narrow Field Of View by design.

The metal layer may be formed on the PCB in any manner. For example—may be done by soldering of the metal to the PCB. For this end, one method for easy fabrication uses mask for solder paste application. The use of flat surface of the metal makes this easy. The solder paste may be applied on the metal rather than on the PCB since the PCB may already have some components assembled. Yet for another example—it may be done by applying conductive glue to the metal surface and then put in the oven as required by the glue manufacturer. Yet for a further example—it may be done using Thermally and Electrically Conductive Adhesive (TECA) film (see COOLSPAN® by Rogers). Such film may be carved in the right shape and placed between the PCB and the metal and then pressed in the oven.

The cavities should be formed in an accurate manner—and positioning the cavities at one side (instead of two) reduces the manufacturing cost.

The orientation, shape, size position of any of the components mentioned above may change from those illustrated in any of the figures.

It should be noted that different waveguides may be formed by different (and even spaced apart) covers of complementary parts—and may not share the same conductive cover.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of step in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described steps are merely illustrative. The multiple may be combined into a single step, a single step may be distributed in additional steps and steps may be executed at least partially overlapping in time. Moreover, alternative embodiments may include multiple instances of a particular step, and the order of steps may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Any reference to the terms “including”, “comprising”, “having” may be applied mutatis mutandis to the term “consisting” and/or may be applied mutatis mutandis to the term “consisting essentially of”.

The phrase “may be X” indicates that condition X may be fulfilled. This phrase also suggests that condition X may not be fulfilled.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A radio frequency (RF) radar comprising:
a first linear antenna array (LAA) that comprises a group of first antennas that are spaced apart from each other by a first distance; wherein the first distance equals a first integer multiplied by a basic distance unit;
a second LAA that comprises groups of second antennas that are spaced apart from each other by a second distance; wherein the second distance equals a second integer multiplied by the basic distance unit; wherein the first integer and the second integer are coprime integers;
wherein a number of second antennas of each group of second antennas is a multiple of the first integer;
wherein a number of first antenna of the group of first antennas is a multiple of the second integer; and
wherein one LAA of the first LAA and the second LAA is a transmission LAA and another LAA of the first LAA and the second LAA is a reception LAA.

2. The MIMO radar according to claim 1, wherein a gap between adjacent groups of second antennas exceeds, by at least a factor of two, the second distance.

3. The MIMO radar according to claim 1, wherein a gap between adjacent groups of second antennas is a multiple of the basic distance unit.

4. The MIMO radar according to claim 1, wherein a gap between adjacent groups of second antennas differs from a multiple of the basic distance unit.

5. The MIMO radar according to claim 1, wherein the basic distance unit equals half a wavelength of at least one signal transmitted by the transmission LAA.

6. The MIMO radar according to claim 1, wherein the first LAA comprises groups of the first antennas; and wherein a number of first antenna of each group of first antennas is the multiple of the second integer.

7. The MIMO radar according to claim 1, wherein a gap between adjacent groups of first antennas exceeds, by at least a factor of two, the first distance.

8. The MIMO radar according to claim 1, wherein the first LAA and the second LAA are parallel to each other.

9. The MIMO radar according to claim 1, wherein the first LAA it the transmission LAA and the second LAA is the reception LAA.

10. The MIMO radar according to claim 1, wherein the first LAA it the reception LAA and the second LAA is the transmission LAA.

11. The MIMO radar according to claim 1, further comprising a third LAA and a fourth LAA.

12. The MIMO radar according to claim 11, wherein the third LAA and the fourth LAA are parallel to each other and are oriented to each one of the first LAA and the second LAA.

13. The MIMO radar according to claim 11, wherein the third LAA comprises a group of third antennas that are spaced apart from each other by a third distance;
wherein the third distance equals a third integer multiplied by an additional basic distance unit;
wherein the fourth LAA comprises groups of fourth antennas that are spaced apart from each other by a fourth distance; wherein the fourth distance equals a fourth integer multiplied by the additional basic distance unit;
wherein the third integer and the fourth integer are coprime integers;
wherein a number of fourth antennas of each group of fourth antennas is a multiple of the third integer;
wherein a number of third antennas of the group of third antennas is a multiple of the fourth integer; and
wherein one LAA of the third LAA and the fourth LAA is a transmission LAA and another LAA of the third LAA and the fourth LAA is a reception LAA.

14. The MIMO radar according to claim 13, wherein the additional basic distance unit equals the basic distance unit.

15. The MIMO radar according to claim 13, wherein the additional basic distance unit differs from the basic distance unit.

16. The MIMO radar according to claim 13, wherein the third LAA consists of a single group of antennas, and the fourth LAA consists of a single group of antennas.

17. A method for operating a multiple input multiple output (MIMO) radar, the method comprising:
transmitting transmitted RF signals by a transmission linear antenna array (LAA);
receiving received RF signals by a reception LAA;
wherein one LAA of the transmission LAA and the reception LAA comprises a group of first antennas that are spaced apart from each other by a first distance; wherein the first distance equals a first integer multiplied by a basic distance unit;
wherein another LAA of the transmission LAA and the reception LAA comprises groups of second antennas that are spaced apart from each other by a second distance;
wherein the second distance equals a second integer multiplied by the basic distance unit;
wherein the first integer and the second integer are coprime integers;
wherein a number of second antennas of each group of second antennas is a multiple of the first integer; and
wherein a number of first antenna of the group of first antennas is a multiple of the second integer.

18. The method according to claim 17, wherein a gap between adjacent groups of second antennas exceeds, by at least a factor of two, the second distance.

19. The method according to claim 17, wherein a gap between adjacent groups of second antennas is a multiple of the basic distance unit.

20. The method according to claim 17, wherein a gap between adjacent groups of second antennas differs from a multiple of the basic distance unit.

21. The method according to claim 17, wherein the basic distance unit equals half a wavelength of at least one signal transmitted by the transmission LAA.

22. The method according to claim 17, wherein the first LAA comprises groups of the first antennas; and wherein a number of first antenna of each group of first antennas is the multiple of the second integer.

23. The method according to claim 17, wherein a gap between adjacent groups of first antennas exceeds, by at least a factor of two, the first distance.

24. The method according to claim 17, wherein the first LAA and the second LAA are parallel to each other.

25. The method according to claim 17, wherein the first LAA it the transmission LAA and the second LAA is the reception LAA.

26. The method according to claim 17, wherein the first LAA it the reception LAA and the second LAA is the transmission LAA.

27. The method according to claim 17, comprising transmitting transmitted RF signals by another transmission LAA and receiving received RF signals by another reception LAA.

28. The method according to claim 27, wherein the other transmission LAA and the other reception LAA are parallel to each other and are oriented to each one of the transmission LAA and the reception LAA.

29. The method according to claim 27, wherein one LAA of the other transmission LAA and the other reception LAA comprises a group of third antennas that are spaced apart from each other by a third distance; wherein the third distance equals a third integer multiplied by an additional basic distance unit;
wherein another LAA of the other transmission LAA and the other reception LAA comprises groups of fourth antennas that are spaced apart from each other by a fourth distance; wherein the fourth distance equals a fourth integer multiplied by the additional basic distance unit;
wherein the third integer and the fourth integer are coprime integers;
wherein a number of fourth antennas of each group of fourth antennas is a multiple of the third integer;
wherein a number of third antennas of the group of third antennas is a multiple of the fourth integer.

30. The method according to claim 28 wherein the additional basic distance unit equals the basic distance unit.

31. A method for target detection using a multiple input multiple output (MIMO) radar, the method comprises:
transmitting, by a transmission unit of the MIMO radar, transmitted beamformed symbols; wherein the transmitted beamformed symbols comprise transmitted beamformed data symbols and transmitted beamformed sequences of pilot symbols,
wherein the transmitted beamformed data symbols are formed by transmitting different codes from different antennas;
receiving, by a reception unit of the MIMO radar, (i) received first echoes of the transmitted beamformed symbols, from a first target, and (ii) received second echoes of the transmitted beamformed symbols, from a second target; wherein the second target is located at a same range bin as the first target, wherein the received first echoes are Doppler shifted, by a Doppler shift, from the received second echoes;
processing the first received echoes and the second received echoes to find the first target and the second target, wherein the processing comprises (i) extracting Doppler information regarding the Doppler shift, and (ii) separating the first echoes from the second echoes, based on the Doppler information.

32. The method according to claim 31 comprising extracting the Doppler information from the beamformed data symbols.

33. The method according to claim 31 comprising extracting the Doppler information regarding the Doppler shift from the pilot symbols.

34. The method according to claim 33 wherein the pilot sequences are concurrently transmitted.

35. The method according to claim 33 wherein the pilot sequences are serially transmitted.

36. The method according to claim 33 wherein a frequency shift between the beamformed sequences is half a pilot repetition frequency of the pilot symbols of the transmitted beamformed sequences of pilot symbols.

37. The method according to claim 33 wherein the pilot symbols are chirps.

38. The method according to claim 33 comprising transmitting, through first transmission antennas of the transmission unit, phase shifted versions of pilot symbols of a first sequence of pilot symbols to provide first transmitted beamformed pilot symbols.

39. The method according to claim 38 comprising transmitting, through second transmission antennas of the transmission unit, phase shifted versions of pilot symbols of a second sequence of pilot symbols to provide second transmitted beamformed pilot symbols.

40. The method according to claim 39 comprising phase shifting the pilot symbols of the first sequence to provide the phase shifted versions of the first sequence, and phase shifting the pilot symbols of the second sequence to provide the phase shifted versions of the second sequence.

41. The method according to claim 40 wherein the pilot symbols of the first sequence are of a same phase, and pilot symbols of the second sequence are of alternating phase.

42. The method according to claim 40 wherein the pilot symbols of the first sequence have phases that are orthogonal to phases of the pilot symbols of the second sequence.

43. The method according to claim 40 wherein the phase shifted versions of the first sequence are phase shifted by zero degrees, minus sixty degrees and sixty degrees respectively, and wherein the phase shifted versions of the second sequence are phase shifted by thirty degrees, sixty degrees and minus ninety degrees, respectively.

44. The method according to claim 39 wherein the first transmission antennas comprise at least three first transmission antennas, and wherein the second antennas comprise at least three second transmission antennas.

45. The method according to claim 44 wherein the first transmission antennas and the second transmission antennas belong to a linear array of antennas.

46. The method according to claim 39 wherein the first transmission antennas comprise at least three first transmission antennas, and wherein the second antennas comprise at least three second transmission antennas.

47. The method according to claim 38 wherein a transmission, through one of the first transmission antennas, of one of the phase shifted versions of the pilot symbols of the first sequence compensates for transmission gaps of a transmission, through another one of the first transmission antennas of another one of the phase shifted versions of the pilot symbols of the first sequence.

48. The method according to claim 38 wherein a transmission, through the other one of the first transmission antennas, of the other one of the phase shifted versions of the pilot symbols of the first sequence compensates for transmission gaps of the transmission, through the one of the first transmission antennas of the one of the phase shifted versions of the pilot symbols of the first sequence.

49. The method according to claim 33 wherein the transmitted beamformed symbols are transmitted in frames, wherein each frame comprises transmitted beamformed sequences of pilot symbols and transmitted beamformed data symbols.

50. The method according to claim 49 wherein a pulse repetition rate of transmitted beamformed pilots are constant within a single frame.

51. The method according to claim 49 wherein a pulse repetition rate of transmitted beamformed pilots of one frame differ from the pulse repetition rate of transmitted beamformed pilots of another frame.

52. A multiple input multiple output (MIMO) radar, the MIMO radar comprising:
a transmission unit that is configured to transmit transmitted beamformed symbols; wherein the transmitted beamformed symbols comprise transmitted beamformed data symbols and transmitted beamformed sequences of pilot symbols, wherein the receiver-separable beamformed sequences of pilot symbols are concurrently transmitted and are receiver-separable;
a reception unit that is configured to receive received echoes, from one or more targets, of the transmitted beamformed symbols; wherein the received echoes comprises echoes of the beamformed data symbols and echoes of the transmitted beamformed sequences of pilot symbols; and
a processor that is configured to process the received echoes to find the one or more targets, wherein a finding of the one or more targets comprises determining, based on the echoes of the transmitted beamformed sequences of pilot symbols, Doppler information regarding the one or more targets.

53. A non-transitory computer readable medium that stores instructions that once executed by a processor, causes the processor to:
control a transmitting, by a transmission unit of the MIMO radar, transmitted beamformed symbols; wherein the transmitted beamformed symbols comprise transmitted beamformed data symbols and transmitted beamformed sequences of pilot symbols, wherein the transmitted beamformed data symbols are formed by transmitting different codes from different antennas;
control a receiving, by a reception unit of the MIMO radar, (i) received first echoes of the transmitted beamformed symbols, from a first target, and (ii) received second echoes of the transmitted beamformed symbols, from a second target; wherein the second target is located at a same range bin as the first target, wherein the received first echoes are Doppler shifted, by a Doppler shift, from the received second echoes;
process the first received echoes to and the second received echoes to find the first target and the second target, wherein the processing comprises (i) extracting Doppler information regarding the Doppler shift, and (ii) separating the first echoes from the second echoes, based on the Doppler information.

54. The non-transitory computer readable medium according to claim 53 comprising extracting the Doppler information from the beamformed data symbols.

55. The non-transitory computer readable medium according to claim 53 comprising extracting the Doppler information regarding the Doppler shift from the pilot symbols.

56. The non-transitory computer readable medium according to claim 77 wherein the pilot sequences are concurrently transmitted.

57. The non-transitory computer readable medium according to claim 77 wherein the pilot sequences are serially transmitted.

58. The non-transitory computer readable medium according to claim 77 wherein a frequency shift between the beamformed sequences is half a pilot repetition frequency of the pilot symbols of the transmitted beamformed sequences of pilot symbols.

59. The non-transitory computer readable medium according to claim 77 wherein the pilot symbols are chirps.

60. The non-transitory computer readable medium according to claim 77 comprising transmitting, through first transmission antennas of the transmission unit, phase shifted versions of pilot symbols of a first sequence of pilot symbols to provide first transmitted beamformed pilot symbols.

61. The non-transitory computer readable medium according to claim 60 comprising transmitting, through second transmission antennas of the transmission unit, phase shifted versions of pilot symbols of a second sequence of pilot symbols to provide second transmitted beamformed pilot symbols.

62. The non-transitory computer readable medium according to claim 61 comprising phase shifting the pilot symbols of the first sequence to provide the phase shifted versions of the first sequence, and phase shifting the pilot symbols of the second sequence to provide the phase shifted versions of the second sequence.

63. The non-transitory computer readable medium according to claim 62 wherein the pilot symbols of the first sequence are of a same phase, and pilot symbols of the second sequence are of alternating phase.

64. The non-transitory computer readable medium according to claim 62 wherein the pilot symbols of the first sequence have phases that are orthogonal to phases of the pilot symbols of the second sequence.

65. The non-transitory computer readable medium according to claim 62 wherein the phase shifted versions of the first sequence are phase shifted by zero degrees, minus sixty degrees and sixty degrees respectively, and wherein the phase shifted versions of the second sequence are phase shifted by thirty degrees, sixty degrees and minus ninety degrees, respectively.

66. The non-transitory computer readable medium according to claim 61 wherein the first transmission antennas comprise at least three first transmission antennas, and wherein the second antennas comprise at least three second transmission antennas.

67. The non-transitory computer readable medium according to claim 66 wherein the first transmission antennas and the second transmission antennas belong to a linear array of antennas.

68. The non-transitory computer readable medium according to claim 61 wherein the first transmission antennas comprise at least three first transmission antennas, and wherein the second antennas comprise at least three second transmission antennas.

69. The non-transitory computer readable medium according to claim 60 wherein a transmission, through one of the first transmission antennas, of one of the phase shifted versions of the pilot symbols of the first sequence compensates for transmission gaps of a transmission, through another one of the first transmission antennas of another one of the phase shifted versions of the pilot symbols of the first sequence.

70. The non-transitory computer readable medium according to claim 60 wherein a transmission, through the other one of the first transmission antennas, of the other one of the phase shifted versions of the pilot symbols of the first sequence compensates for transmission gaps of the transmission, through the one of the first transmission antennas of the one of the phase shifted versions of the pilot symbols of the first sequence.

71. The non-transitory computer readable medium according to claim 77 wherein the transmitted beamformed symbols are transmitted in frames, wherein each frame comprises transmitted beamformed sequences of pilot symbols and transmitted beamformed data symbols.

72. The non-transitory computer readable medium according to claim 61 wherein a pulse repetition rate of transmitted beamformed pilots are constant within a single frame. The non-transitory computer readable medium according to claim 61 wherein a pulse repetition rate of transmitted beamformed pilots of one frame differ from the pulse repetition rate of transmitted beamformed pilots of another frame
